(19) United States
(12) Patent Application Publication
(10) Pub. No.: US 2003/0160805 A1
(43) Pub. Date: Aug. 28, 2003

(54) Image-processing method, image-processing apparatus, and display equipment

(76) Inventors: Bunpei Toji, Iizuka (JP); Tadanori Tezuka, Kaho-Gun (JP); Hiroyuki Yoshida, Kasuya-Gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/370,595

(22) Filed: Feb. 24, 2003

(30) Foreign Application Priority Data
Feb. 22, 2002 (JP) 2002-045924

(51) Int. Cl. G09G 5/02

(52) U.S. Cl. 345/694

(57) ABSTRACT

When an original pixel corresponding to a target pixel is white, and when target pixel-forming three sub-pixels are black, then it is judged that the target pixel is blurred. At this time, a green sub-pixel having the greatest degree of a luminance contribution among the target pixel-forming three sub-pixels are rendered in white. As a result, blurring between object lines is inhibited.

### BACKGROUND OF THE INVENTION

1. Field of the Invention

The present invention relates to an image-processing method for use in per sub-pixel display and an art related thereto.

2. Description of the Related Art

Display equipment that employs various types of display devices have been in customary use. One known type of display equipment heretofore includes a display device such as a color LCD and a color plasma display, in which three light-emitting elements for illuminating three primary colors RGB (red, green, and blue) are aligned with each other in certain sequence to form a pixel. Plural pixels are aligned with each other in a first direction, thereby forming a line. Plural lines are aligned with each other in a second direction perpendicular to the first direction, thereby forming a display screen.

A large number of display devices have display screens reduced in size to a degree that they fail to provide a sufficiently fine display. This problem is commonly seen in the display devices disposed in, e.g., a cellular phone and a mobile computer. In such display devices, small characters and photographs, or complicated pictures, are often blurred and rendered obscure in sharpness.

In order to provide improved display sharpness in such a small display screen, a reference entitled “Sub-Pixel Font-Rendering Technology” is open to the public on the Internet. The reference discusses a per sub-pixel display based on a pixel formed by three light-emitting elements RGB. The present Inventors downloaded the reference on Jun. 19, 2000 from a web site (http://grc.com/) or a subordinate thereof

The above technology is now described with reference to FIGS. 14 to 19. In the following description, an alphabetic character “A” is used as an example of a displayed image.

FIG. 14 is an illustration, showing a line that includes a chain of pixels, each of which consists of the three light-emitting elements. In FIG. 14, a horizontal direction, or a direction in which the light-emitting elements are aligned with each other, is called a first direction, while a vertical direction perpendicular to the first direction is referred to as a second direction.

In the prior art as well as the present invention, the light-emitting elements are not limited to alignment in the order of R, G, and B, but may be arranged serially in any other alphabetical sequence.

Plural pixels, each of which is formed by the three light-emitting elements, are arranged in a row in the first direction to provide a line. Plural lines are aligned with each other in the second direction, thereby providing a display screen.

The sub-pixel technology as discussed above addresses an original image as illustrated in, e.g., FIG. 15. In this example, the character “A” is displayed over a display screen area that consists of seven pixels-by-seven pixels in the first and second directions, respectively. Meanwhile, a font having a resolution as much as three times greater in the first direction than that of the previous character is provided as illustrated in FIG. 16 in order to provide a per sub-pixel display. In FIG. 16, assuming that each of the light-emitting elements RGB is viewed as a single pixel, the character “A” is displayed over a display screen area that consists of twenty-one pixels (=7 * 3 pixels) horizontally by seven pixels vertically.

As illustrated in FIG. 17, a color is determined for each of the pixels of FIG. 15, but not the pixels in FIG. 16. However, color irregularities occur when the determined colors are displayed without being processed. The determined colors must be filtered using coefficients as shown in FIG. 18(a) in order to avoid the color irregularities. As illustrated in FIG. 18(a), the coefficients are correlated with luminance, in which a central target sub-pixel is multiplied by, e.g., a coefficient of 3/9. Contiguously adjacent sub-pixels next to the central sub-pixel are multiplied by a coefficient of 2/9. Sub-pixels next to the contiguously adjacent sub-pixels are multiplied by a coefficient of 1/9, thereby adjusting the luminance of each of the sub-pixels.

The coefficients are now discussed in detail with reference to FIG. 19. In FIG. 19, the symbol “*” in each square box denotes any one of the three light-emitting elements for illuminating three primary colors RGB. As seen from FIG. 19, a chain of coefficients starts from the first stage in the lower direction of FIG. 19.

While such a coefficient system is advanced to the second stage from the first stage, each of the three light-emitting elements collects uniform energy. More specifically, only a coefficient of ⅓ is available at the first stage. Similarly, while the coefficient system is advanced to the third stage from the second stage, each of the three light-emitting elements collects uniform energy. As a result, only the coefficient of ⅓ is available at the second stage as well.

A target sub-pixel at the third stage is reached from a central sub-pixel at the first stage through a total of three different paths, i.e., central, left, and right paths at the second stage. As a result, the central sub-pixel at the first stage provides a first and second stages-combined coefficient of 3/9(=⅓*⅓+⅓*⅓+⅓*⅓).

The target sub-pixel at the third stage is reached from horizontally contiguously adjacent sub-pixels next to the central sub-pixel at the first stage through two different paths. As a result, each of the horizontally contiguously adjacent sub-pixels next to the central sub-pixel at the first stage provides a combined coefficient of 2/9(=1/3*1/3+1/3*1/3).

The target sub-pixel at the third stage is reached through a single path from both sub-pixels next to the horizontally contiguously adjacent sub-pixels at the first stage. As a result, each of the sub-pixels next to the horizontally contiguously adjacent sub-pixels at the first stage provides a combined coefficient of 1/9 (=1/3*1/3).

The use of the above coefficients provides a target sub-pixel, after filtering processing, with a luminance value “V (n)” equal to (1/9)*Vn−2+(2/9)*Vn−1+(3/9)*Vn+(2/9)*Vn+1+(1/9)*Vn+2.

The character “n” as given above denotes a position of a target sub-pixel. Vn−2 is a luminance value of a leftmost sub-pixel next to a sub-pixel located leftward next to the target sub-pixel. Vn−1 is a luminance value of the sub-pixel located leftward next to the target sub-pixel. Vn is a luminance value of the target pixel. Vn+1 is a luminance value of a rightward sub-pixel next to the target pixel. Vn+2 is a luminance value of a rightmost sub-pixel next to the rightward sub-pixel.

The luminance values Vn−2, Vn−1, Vn, Vn+1, and Vn+2 are luminance values before filtering processing.

In the sub-pixel rendering technology as discussed above, various arts have been developed to realize a higher quality display. However, the developed arts are not open to the public, and are therefore beyond the category of a prior art.

A drawback to the developed arts is that a space between object lines representative of an object (a character, a symbol, a figure, or a combination thereof) is likely to be blurred upon a per sub-pixel display, with the result of an inexplicitly displayed object.

### OBJECTS AND SUMMARY OF THE INVENTION

In view of the above, an object of the present invention is to provide an image-processing method and an art related thereto, designed to suppress blurring between object lines, thereby providing an explicitly displayed object.

A first aspect of the present invention provides an image-processing method comprising: aligning three sub-pixels with each other in a sequence to form a pixel, the three sub-pixels corresponding to three light-emitting elements that are operable to illuminate three primary colors RGB (red, green, and blue), respectively; aligning a plurality of the pixels with each other in a first direction to form a line; aligning a plurality of the lines with each other in a second direction perpendicular to the first direction, thereby forming a display screen; when an original pixel corresponding to a target pixel of an image to be displayed on a display device is in a first display state, and when target pixel-forming three sub-pixels are in a second display state, then permitting one of the target pixel-forming three sub-pixels in the second display state to be rendered in the first display state, thereby providing a target pixel including a sub-pixel that is in the first display state; when the original pixel corresponding to the target pixel of the image to be displayed on the display device is in the first display state, and when only a central sub-pixel among the target pixel-forming three sub-pixels is in the first display state, then permitting one of the sub-pixels in the second display state among the target pixel-forming three sub-pixels to be rendered in the first display state, thereby providing a target pixel including two sub-pixels that are in the first display state; and processing the image to be displayed on the display device.

As a result, it is judged that the displayed target pixel is blurred, either when the original pixel corresponding to the target pixel of the image to be displayed on the display device is in the first display state, and when the target pixel-forming three sub-pixels are in the second display state, or when the original pixel corresponding to the target pixel of the image to be displayed on the display device is in the first display state, and when only the central sub-pixel among the target pixel-forming three sub-pixels is in the first display state.

In this instance, when the sub-pixels in the first display state display the background, and when the sub-pixels in the second display state display an object (a character, a symbol, a figure, or a combination thereof), then it is judged that the target pixels representative of the object are blurred, and that blurring between object lines occurs.

To overcome such an inconvenience, in each of the target pixels, an increase in the number of the sub-pixels in the first display state for representing the background inhibits the blurring between the object lines. This feature provides an explicitly displayed object.

Such blur-inhibiting realizes the explicitly displayed object, even after subsequent filtering processing.

A second aspect of the present invention provides an image-processing method comprising: aligning three sub-pixels with each other in a sequence to form a pixel, the three sub-pixels corresponding to three light-emitting elements that are operable to illuminate three primary colors RGB, respectively; aligning a plurality of the pixels with each other in a first direction to form a line; aligning a plurality of the lines with each other in a second direction perpendicular to the first direction, thereby forming a display screen; searching an original image of an image to be displayed on a display device in order to detect an original pixel in a first display state; when it is found, as a result of detecting the original pixel, that target pixel-forming three sub-pixels corresponding to the detected original pixel in the first display state are in a second display state, then permitting one of the target pixel-forming three sub-pixels in the second display state to be rendered in the first display state, thereby providing a target pixel including a sub-pixel that is in the first display state; when it is found, as a result of detecting the original pixel, that only a central sub-pixel among the target pixel-forming three sub-pixels corresponding to the detected original pixel in the first display state is in the first display state, then permitting one of the sub-pixels in the second display state among the target pixel-forming three sub-pixels to be rendered in the first display state, thereby providing a target pixel including two sub-pixels that are in the first display state; and processing the image to be displayed on the display device.

As a result, it is judged that the displayed target pixel is blurred, either when the original pixel corresponding to the target pixel of the image to be displayed on the display device is in the first display state, and when the target pixel-forming three sub-pixels are in the second display state, or when the original pixel corresponding to the target pixel of the image to be displayed on the display device is in the first display state, and when only the central sub-pixel among the target pixel-forming three sub-pixels are in the first display state.

In this instance, when the sub-pixels in the first display state displays the background, and when the sub-pixels in the second display state display an object (a character, a symbol, a figure, or a combination thereof), then it is judged that the target pixels representative of the object are blurred, and that blurring between object lines occurs.

To overcome such an inconvenience, in each of the target pixels, an increase in the number of the sub-pixels in the first display state for representing the background inhibits the blurring between the object lines. This feature provides an explicitly displayed object.

Such a blur-inhibiting step realizes the explicitly displayed object, even after subsequent filtering processing.

A third aspect of the present invention provides an image-processing method as defined in the first aspect of the present invention, wherein the step of providing the target pixel including the single sub-pixel that is in the first display state comprises a step of permitting a sub-pixel having the greatest degree of a luminance contribution among the target pixel-forming three sub-pixels to be rendered in the first display state, thereby providing a target pixel including a sub-pixel that is in the first display state, and wherein the step of providing the target pixel including the two sub-pixels that are in the first display state comprises a step of permitting a sub-pixel having a greater degree of the luminance contribution between two sub-pixels among the target pixel-forming three sub-pixels except for the central sub-pixel to be rendered in the first display state, thereby providing a target pixel including two sub-pixels that are in the first display state.

As a result, blurring between object lines can be inhibited to a greater degree, and a further explicitly displayed object is provided.

A fourth aspect of the present invention provides an image-processing method comprising steps of: aligning three sub-pixels with each other in a sequence to form a pixel, the three sub-pixels corresponding to three light-emitting elements that are operable to illuminate three primary colors RGB, respectively; aligning a plurality of the pixels with each other in a first direction to form a line; aligning a plurality of the lines with each other in a second direction perpendicular to the first direction, thereby forming a display screen; on the assumption that an original pixel corresponding to a target pixel is in a first display state and target pixel-forming three sub-pixels are in a second display state when an image to be displayed on a display device is filtered, then outputting filtering processing results of a state in which one of single pixel-forming three sub-pixels is in the first display state and the remaining two sub-pixels are in the second display state; on the assumption that the original pixel corresponding to the target pixel is in the first display state and only a central sub-pixel among the target pixel-forming three sub-pixels is in the first display state when the image to be displayed on the display device is filtered, then outputting filtering processing results of a state in which two sub-pixels including the central sub-pixel among the single pixel-forming three sub-pixels are in the first display state and the remaining sub-pixel is in the second display state; and processing the image to be displayed on the display device.

As a result, it is judged that the displayed target pixel is blurred, either when the original pixel corresponding to the target pixel of the image to be displayed on the display device is in the first display state, and when the target pixel-forming three sub-pixels are in the second display state, or when the original pixel corresponding to the target pixel of the image to be displayed on the display device is in the first display state, and when only the central sub-pixel among the target pixel-forming three sub-pixels are in the first display state.

In this instance, when the sub-pixels in the first display state displays the background, and when the sub-pixels in the second display state display an object (a character, a symbol, a figure, or a combination thereof), then it is judged that the target pixels representative of the object are blurred, and that blurring between object lines occurs.

To smooth out such an inconvenience, filtering processing results for a pixel including a greater number of sub-pixels in the first display state for representing the background than the number of the target pixels judged as blurred are outputted as filtering processing results for each of the target pixels judged as blurred.

This step inhibits the blurring between the object lines, and consequently provides an explicitly displayed object. In addition, blur-inhibiting processing and filtering processing are executable at one time.

A fifth aspect of the present invention provides an image-processing method as defined in the fourth aspect of the present invention, wherein the step of outputting the filtering processing results of the state in which one of the single pixel-forming three sub-pixels is in the first display state and the remaining two sub-pixels are in the second display state comprises a step of outputting filtering processing results of a state in which a sub-pixel having the greatest degree of a luminance contribution among the single pixel-forming three sub-pixels is in the first display state and the remaining two sub-pixels are in the second display state; and wherein the step of outputting the filtering processing results of the state in which the two sub-pixels including the central sub-pixel among the single pixel-forming three sub-pixels are in the first display state and the remaining sub-pixel is in the second display state comprises a step of outputting filtering processing results of a state in which the central sub-pixel and a sub-pixel having a greater degree of the luminance contribution between the remaining two sub-pixels among the single pixel-forming three sub-pixels are in the first display state and the remaining sub-pixel is in the second display state.

As a result, blurring between object lines can be inhibited to a greater degree, thereby providing a further explicitly displayed object.

A sixth aspect of the present invention provides an image-processing method comprising steps of: aligning three sub-pixels with each other in a sequence to form a pixel, the three sub-pixels corresponding to three light-emitting elements that are operable to illuminate three primary colors RGB, respectively; aligning a plurality of the pixels with each other in a first direction to form a line; aligning a plurality of the lines with each other in a second direction perpendicular to the first direction, thereby forming a display screen; checking a display state of an original pixel that corresponds to a target pixel of an image to be displayed on a display device; when it is found that the original pixel is in a first display state, then obtaining, from a first filter result storage unit, filtering processing results according to a display state of each of a total of a m-number (m is a natural number) of sub-pixels aligned with each other in the first direction about the target pixel, thereby rendering the obtained filtering processing results being as filtering processing results for target pixel-forming three sub-pixels; when it is found that the original pixel is in a second display state, then obtaining, from a second filter result storage unit, filtering processing results according to a display state of each of a total of the m-number of sub-pixels aligned with each other in the first direction about the target pixel, thereby rendering the obtained filtering processing results being as filtering processing results for the target pixel-forming three sub-pixels; and processing the image to be displayed on the display device, wherein the first and second filter result storage units each contain filtering processing results for single pixel-forming three sub-pixels according to a display state of each of a total of the m-number of sub-pixels aligned with each other in the first direction about a single pixel that consists of the three sub-pixels, wherein the first filter result storage unit contains, in accordance with a total of the m-number of sub-pixels aligned with each other about a central pixel consisting of three sub-pixels that are in the second display state, filtering processing results of a state in which one of the three sub-pixels for forming the central pixel is in the first display state and the remaining two sub-pixels are in the second display state, and wherein the second filter result storage unit contains, in accordance with a total of the m-number of sub-pixels aligned with each other about a central pixel consisting of three sub-pixels in which only a central sub-pixel is in the first display state, filtering processing results of a state in which two sub-pixels including the central sub-pixel among the three sub-pixels for forming the central pixel are in the first display state and the remaining sub-pixel is in the second display state.

As a result, it is judged that the displayed target pixel is blurred, either when the original pixel corresponding to the target pixel of the image to be displayed on the display device is in the first display state, and when the target pixel-forming three sub-pixels are in the second display state, or when the original pixel corresponding to the target pixel of the image to be displayed on the display device is in the first display state, and when only the central sub-pixel among the target pixel-forming three sub-pixels are in the first display state.

In this instance, when the sub-pixels in the first display state displays the background, and when the sub-pixels in the second display state display an object (a character, a symbol, a figure, or a combination thereof), then it is judged that the target pixels representative of the object are blurred, and that blurring between object lines occurs.

To overcome such an inconvenience, filtering processing results for a pixel including a greater number of sub-pixels in the first display state for representing the background than the number of the target pixels judged as blurred are placed in advance into the first filter result storage unit as filtering processing results for each of the target pixels judged as blurred

Accordingly, the filtering processing results for the pixel including a greater number of sub-pixels in the first display state for representing the background than the number of the target pixels judged as blurred can be obtained from the first filter result storage unit as filtering processing results for each of the target pixels judged as blurred.

This step inhibits the blurring between the object lines. This feature provides an explicitly displayed object. In addition, blur-inhibiting processing and filtering processing are executable at one time.

Furthermore, only referencing the first filter result storage unit makes it feasible to perform the blur-inhibiting processing and the filtering processing at one time. This feature realizes high-speed processing.

A seventh aspect of the present invention provides an image-processing method as defined in the sixth aspect of the present invention, wherein the first filter result storage unit contains, in accordance with to a total of the m-number of sub-pixels aligned with each other about the central pixel consisting of the three sub-pixels that are in the second display state, filtering processing results of a state in which a sub-pixel having the greatest degree of a luminance contribution among the three sub-pixels for forming the central pixel is in the first display state and the remaining two sub-pixels are in the second display state, and wherein the first filter result storage unit contains, in accordance with a total of the m-number of sub-pixels aligned with each other about the central pixel consisting of the three sub-pixels in which only the central sub-pixel is in the first display state, filtering processing results of a state in which the central sub-pixel and a sub-pixel having a greater degree of the luminance contribution between the remaining two sub-pixels among the three sub-pixels for forming the central pixel are in the first display state and the remaining sub-pixel is in the second display state.

As a result, blurring between object lines can be inhibited to a greater degree, and a further explicitly displayed object is provided.

An eight aspect of the present invention provides an image-processing method comprising steps of: aligning three sub-pixels with each other in a sequence to form a pixel, the three sub-pixels corresponding to three light-emitting elements that are operable to illuminate three primary colors RGB, respectively; aligning a plurality of the pixels with each other in a first direction to form a line; aligning a plurality of the lines with each other in a second direction perpendicular to the first direction, thereby forming a display screen; checking a display state of an original pixel that corresponds to a target pixel of an image to be displayed on a display device; obtaining, from a filter result storage unit, filtering processing results according to a display state of each of a total of a m-number (m is a natural number) of sub-pixels aligned with each other in the first direction about the target pixel, thereby rendering the obtained filtering processing results as filtering processing results for target pixel-forming three sub-pixels; and processing the image to be displayed on the display device, wherein the filter result storage unit contains filtering processing results for single pixel-forming three sub-pixels according to a display state of each of a total of the m-number of sub-pixels aligned with each other in the first direction about a single pixel that consists of the three sub-pixels, and wherein the step of rendering the obtained filtering processing results as filtering processing results for the target pixel-forming three sub-pixels comprises steps of: when the original pixel is in a first display state, and when the target pixel-forming three sub-pixels are in a second display state, then obtaining, from the filter result storage unit, filtering processing results of a state in which one of central pixel-forming three sub-pixels is in the first display state and the remaining two sub-pixels are in the second display state, thereby rendering the obtained filtering processing results as filtering processing results for the target pixel-forming three sub-pixels; and when the original pixel is in the first display state, and when only a central sub-pixel among the target pixel-forming three sub-pixels is in the first display state, then obtaining, from the filter result storage unit, filtering processing results of a state in which two sub-pixels including the central sub-pixel among the central pixel-forming three sub-pixels are in the first display state and the remaining sub-pixel is in the second display state, thereby rendering the obtained filtering processing results as filtering processing results for the target pixel-forming three sub-pixels.

As a result, it is judged that the displayed target pixel is blurred, either when the original pixel corresponding to the target pixel of the image to be displayed on the display device is in the first display state, and when the target pixel-forming three sub-pixels are in the second display state, or when the original pixel corresponding to the target pixel of the image to be displayed on the display device is in the first display state, and when only the central sub-pixel among the target pixel-forming three sub-pixels are in the first display state.

In this instance, when the sub-pixels in the first display state display the background, and when the sub-pixels in the second display state display an object (a character, a symbol, a figure, or a combination thereof), then it is judged that the target pixels representative of the object are blurred, and that blurring between object lines occurs.

To obviate such an inconvenience, filtering processing results for a pixel including a greater number of sub-pixels in the first display state for representing the background than the number of the target pixels judged as blurred are obtained from the filter result storage unit as filtering processing results for each of the target pixels judged as blurred

This step inhibits the blurring between the object lines, and consequently provides an explicitly displayed object. In addition, blur-inhibiting processing and filtering processing are executable at one time.

Furthermore, only one filter result storage unit is required, and a memory having a smaller capacity can be used, when compared with when two filter result storage units are employed.

A ninth aspect of the present invention provides an image-processing method as defined in the eight aspect of the present invention, wherein the step of obtaining, from the filter result storage unit, the filtering processing results of the state in which one of the central pixel-forming three sub-pixels is in the first display state and the remaining two sub-pixels are in the second display state, thereby rendering the obtained filtering processing results as filtering processing results for the target pixel-forming three sub-pixels comprises a step of obtaining, from the filter result storage unit, filtering processing results of a state in which a sub-pixel having the greatest degree of a luminance contribution among the central pixel-forming three sub-pixels is in the first display state and the remaining two sub-pixels are in the second display state, thereby rendering the obtained filtering processing results as filtering processing results for the target pixel-forming three sub-pixels, and wherein the step of obtaining, from the filter result storage unit, the filtering processing results of the state in which two sub-pixels including the central sub-pixel are in the first display state and the remaining sub-pixel is in the second display state, thereby rendering the obtained filtering processing results as filtering processing results for the target pixel-forming three sub-pixels comprises a step of obtaining, from the filter result storage unit, filtering processing results of a state in which the central sub-pixel and a sub-pixel having a greater degree of the luminance contribution between the remaining two sub-pixels among the central pixel-forming three sub-pixels are in the first display state and the remaining sub-pixel is in the second display state, thereby rendering the obtained filtering processing results as filtering processing results for the target pixel-forming three sub-pixels.

As a result, blurring between object lines can be inhibited to a greater degree, thereby providing a further explicitly displayed object.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram, illustrating exemplary display equipment according to a first embodiment of the present invention;

FIG. 2(a) is a first definition of blurring of a target pixel according to the first embodiment;

FIG. 2(b) is a second definition of blurring of a target pixel according to the first embodiment;

FIG. 3(a) is an illustration, showing an original image according to the first embodiment;

FIG. 3(b) is an illustration, showing a per sub-pixel image before blur-inhibiting processing of a target pixel according to the first embodiment;

FIG. 3(c) is an illustration, showing a per sub-pixel image after the blur-inhibiting processing of the target pixel according to the first embodiment;

FIG. 4(a) is an illustration, showing an original image according to the first embodiment;

FIG. 4(b) is an illustration, showing a per sub-pixel image before blur-inhibiting processing of a target pixel according to the first embodiment;

FIG. 4(c) is an illustration, showing a per sub-pixel image after the blur-inhibiting processing of the target pixel according to the first embodiment;

FIG. 5(a) is an illustration, showing exemplary coefficients for use in filtering processing of a red sub-pixel according to the first embodiment;

FIG. 5(b) is an illustration, showing exemplary coefficients for use in filtering processing of a green sub-pixel according to the first embodiment;

FIG. 5(c) is an illustration, showing exemplary coefficients for use in filtering processing of a blue sub-pixel according to the first embodiment;

FIG. 6 is a descriptive illustration, showing details of exemplary filtering processing according to the first embodiment;

FIG. 7 is an exemplary flowchart, illustrating a flow of processing in the display equipment according to the first embodiment;

FIG. 8 is an exemplary flowchart, illustrating correcting or blur-inhibiting processing according to the first embodiment;

FIG. 9 is a block diagram, illustrating exemplary display equipment according to a second embodiment;

FIG. 10 is a descriptive illustration, showing exemplary blur-inhibiting processing and filtering processing according to the second embodiment;

FIG. 11 is an exemplary flowchart, illustrating a flow of processing in the display equipment according to the second embodiment;

FIG. 12 is a block diagram, illustrating exemplary display equipment according to a third embodiment;

FIG. 13 is an exemplary flowchart, illustrating a flow of processing in the display equipment according to the third embodiment;

FIG. 14 is a simulated illustration, showing a line according to the prior art;

FIG. 15 is an illustration, showing an original image according to the prior art;

FIG. 16 is an illustration, showing a three-times magnified image according to the prior art;

FIG. 17 is a descriptive illustration, showing how colors are determined according to the prior art;

FIG. 18(a) is a descriptive illustration, showing prior art filtering processing coefficients;

FIG. 18(b) is an illustration, showing prior art filtering processing results; and

FIG. 19 is a descriptive illustration, showing prior art filtering processing coefficients.

### DETAILED DESCRIPTION OF THE PREFERRED EMBODIMENTS

Embodiments of the present invention will now be described with reference to the drawings.

(Embodiment 1)

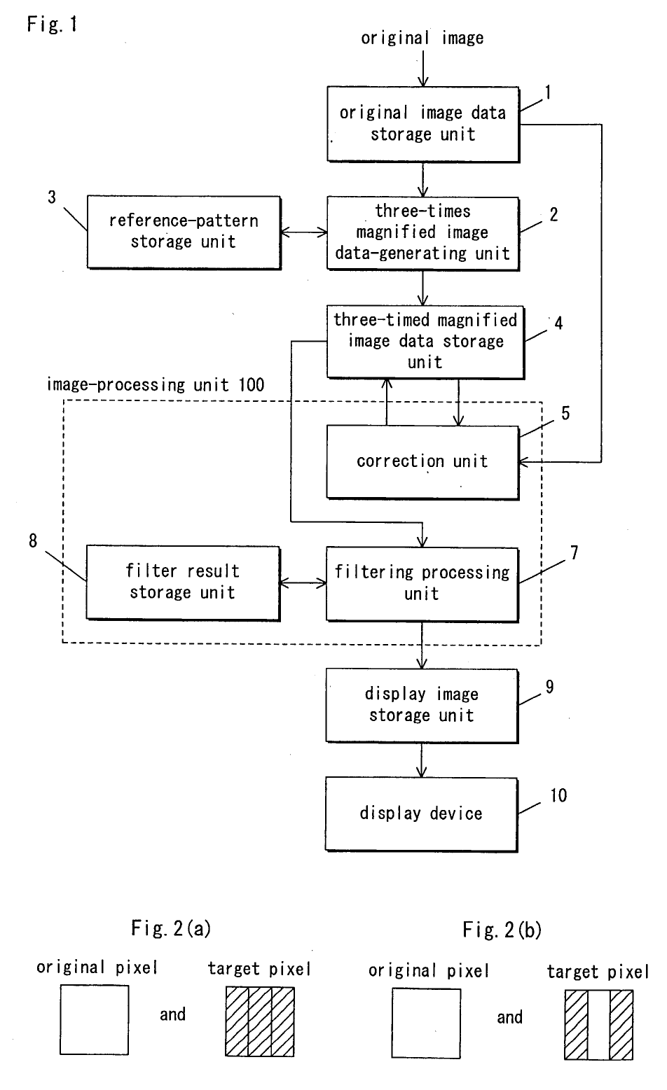

FIG. 1 is a block diagram, illustrating exemplary display equipment according to a first embodiment of the present invention. As illustrated in FIG. 1, the display equipment includes an original image data storage unit 1, a three-times magnified image data-generating unit 2, a reference pattern storage unit 3, a three-times magnified image data storage unit 4, an image-processing unit 100, a display image storage unit 9, and a display device 10.

The image-processing unit 100 includes a correction unit 5, a filtering processing unit 7, and a filter result storage unit 8.

The display device 10 is now described. In the display device 10, three light-emitting elements for illuminating three primary colors RGB (red, green, and blue) respectively are aligned in a sequence to form a pixel. A plurality of the pixels are aligned in series in a first direction, thereby forming a line. A plurality of the lines are aligned in a second direction perpendicular to the first direction, thereby forming a display screen. More specifically, the display device 10 may be any one of a color LCD (liquid crystal display), a color plasma display, and an organic EL (electroluminescence). The display device 10 includes drivers for driving such light-emitting elements.

A sub-pixel is now discussed in brief. In general, the sub-pixel is a minimum element that forms a pixel. In the present embodiment, the sub-pixel is an element obtained by cutting the single pixel into three equal parts in the first direction.

According to the present embodiment, three sub-pixels RGB for forming a single pixel correspond to light-emitting elements RGB, respectively.

The original image data storage unit 1 is now described. The original image data storage unit 1 stores entered image data (hereinafter called “original image data”).

The original image data is formed by per-pixel data that displays an object (a character, a symbol, a figure, and a combination thereof). The following description assumes that the original image data is binary raster image data that represent characters displayed in black on a white background.

The three-times magnified image data-generating unit 2 and the reference pattern storage unit 3 are now described.

The three-times magnified image data-generating unit 2 extracts a bitmap pattern from the original image data stored in the original image data storage unit 1.

The extracted bitmap pattern excludes a target original pixel from a rectangular pattern that is made up of the target original pixel and surrounding pixels about the target original pixel. The bitmap pattern consists of pixels whose total number is ((2p+1)*(2q+1)−1) (p, q are natural numbers). The bitmap pattern includes different combinations of the ((2p+1)*(2q+1)−1) power of two.

The target original pixel as given above refers to a pixel, to which the original image data are allocated. In other words, the target original pixel is a pixel to be now processed.

The reference pattern storage unit 3 stores a reference pattern. The reference pattern is equal in shape to a corresponding bitmap pattern extracted by the three-times magnified image data-generating unit 2.

Therefore, the reference pattern storage unit 3 stores the reference pattern having different combinations of the ((2p+1)*(2q+1)−1) power of two.

In order to provide a smoother line than a line drawn on a per-pixel basis in an original image when the image is displayed on a per sub-pixel basis, the reference pattern storage unit 3 stores, for each of the reference patterns, a three-times magnified pattern (three-times magnified data) of a target original pixel, a pattern (data) to be allocated to an x-number (x is a natural number) of leftward adjacent sub-pixels next to a target pixel, and a pattern (data) to be allocated to a y-number (y is a natural number) of rightward adjacent sub-pixels next to the target pixel.

The three-time magnified image data-generating unit 2 searches the reference pattern storage unit 3 for a reference pattern matched with the extracted bitmap pattern. The three-times magnified image data-generating unit 2 determines, in accordance with the searched reference pattern, the three-times magnified pattern of the target original pixel, the pattern to be allocated to the x-number (x is a natural number) of leftward adjacent sub-pixels next to the target pixel, and the pattern to be allocated to the y-number (y is a natural number) of rightward adjacent sub-pixels next to the target pixel.

The target pixel in the reference pattern storage unit 3 and the three-times magnified image data-generating unit 2 refers to a pixel that is made up of three sub-pixels, to which the three-times magnified pattern (three-times magnified data) of the target original pixel is allocated. In other words, the target pixel in the reference pattern storage unit 3 and the three-times magnified image data-generating unit 2 is a pixel to be now processed.

The following assumes that p=q=1 and x=y=1. The assumption p=q=1 means that the reference pattern as well as the extracted bitmap pattern consists of eight pixels. The assumption of x=y=1 allows the three-times magnified image data-generating unit 2 to determine the three-times magnified pattern of the target original pixel, the pattern allocated to the leftward adjacent sub-pixel next to the target pixel, and the pattern allocated to the rightward adjacent sub-pixel next to the target pixel.

While defining every pixel as a target original pixel, the three-times magnified image data-generating unit 2 determines, for all of the target original pixels in the original image data, the three-times magnified pattern of the target original pixel, the pattern allocated to the leftward adjacent sub-pixel next to the target pixel, and the pattern allocated to the rightward adjacent sub-pixel next to the target pixel.

In the present embodiment, the pattern (data) to be allocated on a per sub-pixel basis, not on a per-pixel basis as seen in the original image data, is called three-times magnified image data.

The three-times magnified image data storage unit 4 is now described. The three-times magnified image data storage unit 4 stores the three-times magnified image data generated by the three-times magnified image data-generating unit 2.

The correction unit 5 is now described. Assuming that a target pixel is blurred when the three-times image data stored in the three-times magnified image data storage unit 4 is allocated to the target pixel, the correction unit 5 corrects the three-times magnified image data to be allocated to the target pixel.

The target pixel in the correction unit 5 refers to a pixel that is made up of three sub-pixels, to which the three-times magnified image data stored in the three-times magnified image data storage unit 4 is allocated. In other words, the target pixel in the correction unit 5 is a pixel to be now processed.

The following discusses a definition in which a displayed target pixel is blurred.

FIG. 2 is a descriptive illustration, defining a blurred target pixel. FIG. 2(a) illustrates a first blurring definition. FIG. 2(b) illustrates a second blurring definition. FIGS. 2(a) and 2(b) each illustrate both an original pixel and a target pixel, each of which corresponds to a single pixel. The target pixel includes three sub-pixels. Each hatched sub-pixel denotes a black sub-pixel.

When the original pixel and the target pixel are displayed as illustrated in either FIG. 2(a) or FIG. 2(b), then the correction unit 5 judges that the displayed target pixel is blurred.

More specifically, as illustrated in FIG. 2(a), assuming that an original pixel corresponding to a target pixel is displayed in white, and that target pixel-forming three sub-pixels are all displayed in black when three-times magnified image data stored in the three-times magnified image data storage unit 4 is allocated to the target pixel, the correction unit 5 judges that the displayed target pixel is blurred.

Referring now to FIG. 2(b), assuming that the original pixel corresponding to the target pixel is displayed in white, and that only a central sub-pixel among the target pixel-forming three sub-pixels is displayed in white when the three-times magnified image data stored in the three-times magnified image data storage unit 4 is allocated to the target pixel, the correction unit 5 judges that the displayed target pixel is blurred.

The original pixel as mentioned above refers to a pixel, to which the original image data stored in the original image data storage unit 1 is allocated.

In the following descriptions, it is defined that “white” in a display state of a sub-pixel means that a light-emitting element corresponding to the sub-pixel is most illuminated, and that “black” in a display state of a sub-pixel means that a light-emitting element corresponding to the sub-pixel is least illuminated or turned off.

The way in which the correction unit 5 corrects the three-times magnified image data is now described in detail with reference to the drawings.

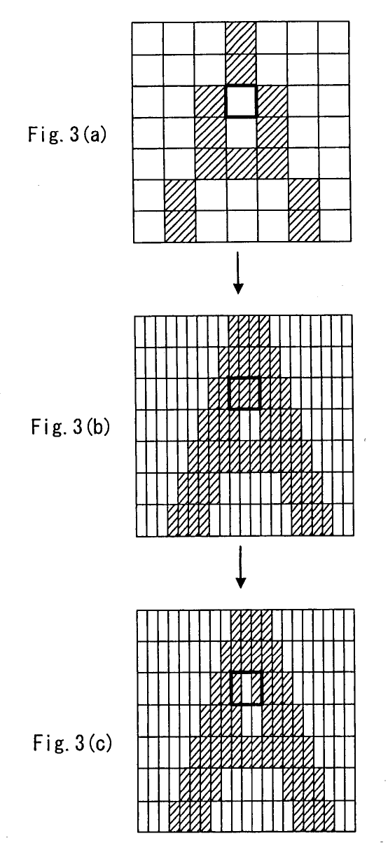

FIG. 3 is a first illustration, showing how the correction unit 5 corrects the three-times magnified image data. FIG. 3(a) is an illustration, showing an exemplary original image (a per-pixel image) displayed in accordance with original image data stored in the original image data storage unit 1. FIG. 3(b) is an illustration, showing an exemplary three-times magnified precision image (a per sub-pixel image) displayed in accordance with three-times magnified image data stored in the three-times image data storage unit 4. FIG. 3(c) is an illustration, showing an exemplary three-times magnified precision image (a per sub-pixel image) that is obtained by correcting the three-times magnified image data using the correction unit 5.

In FIGS. 3(a), (b), and (c), horizontal and vertical directions are defined as first and second directions, respectively.

In FIG. 3(a), a line consisting of seven pixels aligned with each other in the first direction is formed, and then seven lines, each of which is the line consisting of the seven pixels, are aligned with each other in the second direction. In this way, the original image is formed.

In FIGS. 3(b) and (c), a line consisting of twenty-one pixels aligned with each other in the first direction is formed, and then seven lines, each of which is the line consisting of the twenty-one pixels, are aligned with each other in the second direction. In this way, the three-times magnified precision image is formed.

In FIGS. 3(b) and (c), assume that the sub-pixels are aligned in the order of RGB from the left to the right in the first direction for each pixel.

FIGS. 3(a), (b), and (c) illustrate the character “A”.

In the description according to FIG. 3, a pixel enclosed by a bold line and formed by three sub-pixels that are located on the third row and the tenth-to-twelfth columns in FIGS. 3(b) and 3(c) is viewed as a target pixel. In FIG. 3(a), an original pixel enclosed by a bold line and located on the third row and the fourth column is viewed as an original pixel that corresponds to the target pixel. In FIGS. 3(a), (b), and (c), the horizontal direction is defined as a row, while the vertical direction is defined as a column. The rows are numbered, beginning from the top of FIGS. 3(a), (b), and (c). The columns are numbered, beginning from the left of FIGS. 3(a), (b), and (c).

In FIG. 3(a), each hatched pixel denotes a black pixel. In FIGS. 3(b) and (c), each hatched sub-pixel denotes a black sub-pixel.

When the original pixel corresponding to the target pixel is illuminated in white as shown in FIG. 3(a), and when the target pixel-forming three sub-pixels are all illuminated in black as shown in FIG. 3(b), then the correction unit 5 corrects corresponding three-times magnified image data to permit one of the target pixel-forming three sub-pixels to be illuminated in white as illustrated in FIG. 3(c).

In this way, one of the three sub-pixels displayed in black is illuminated in white, thereby inhibiting target pixel blurring.

In this instance, the correction unit 5 corrects the corresponding three-times magnified image data to permit a sub-pixel having the greatest degree of a luminance contribution among the target pixel-forming three sub-pixels to be illuminated in white.

The three primary colors RGB have a luminance contribution in the ratio of about 3:6:1, respectively.

Accordingly, the correction unit 5 corrects the corresponding three-times magnified image data to illuminate a green sub-pixel in white as shown in FIG. 3(c) because the green sub-pixel has the highest level of the luminance contribution.

In this way, a sub-pixel having the greatest degree of the luminance contribution among the black sub-pixels is displayed in white, thereby inhibiting the target pixel blurring to a greater extent.

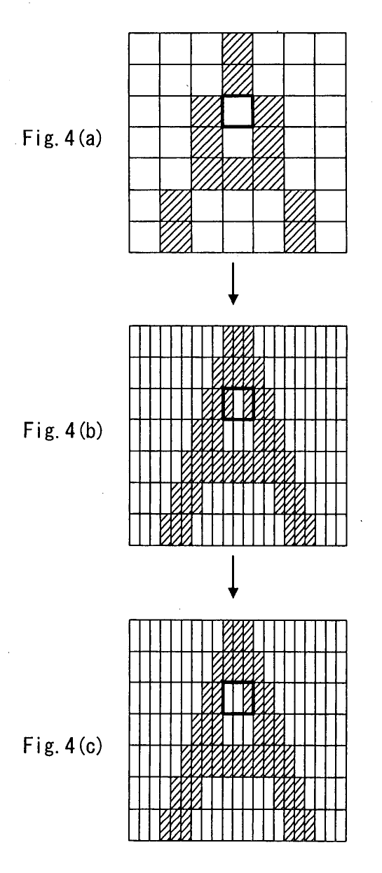

FIG. 4 is a second illustration, showing how the correction unit 5 corrects three-times magnified image data. FIG. 4(a) is an illustration, showing an exemplary original image (a per-pixel image) displayed in accordance with the original image data stored in the original image data storage unit 1. FIG. 4(b) is an illustration, showing an exemplary three-times magnified precision image (a per sub-pixel image) displayed in accordance with the three times magnified image data stored in the three-times magnified image data storage unit 4. FIG. 4(c) is an illustration, showing an exemplary three-times magnified precision image (a per sub-pixel image) that is obtained by correcting the three-times magnified image data using the correction unit 5.

In the description according to FIG. 4, a pixel enclosed by a bold line and formed by three sub-pixels that are located on the third row and the tenth-to-twelfth columns as illustrated in FIGS. 4(b) and 4(c) is viewed as a target pixel. In FIG. 4(a), an original pixel enclosed by a bold line and located on the third row and the fourth column is viewed as an original pixel that corresponds to the target pixel.

When the original pixel corresponding to the target pixel is illuminated in white as shown in FIG. 4(a), and when only a central sub-pixel among target pixel-forming three sub-pixels is illuminated in white as shown in FIG. 4(b), then the correction unit 5 corrects corresponding three-times magnified image data to permit one of two sub-pixels displayed in black among the target pixel-forming three sub-pixels to be illuminated in white. As a result, two sub-pixels including the central sub-pixel are displayed in white as illustrated in FIG. 4(c).

In this way, one of the sub-pixels displayed in black is illuminated in white, thereby displaying a total of two sub-pixels in white. This step inhibits the target pixel blurring.

In this instance, the correction unit 5 corrects the corresponding three-times magnified image data to permit a sub-pixel having a greater level of the luminance contribution between two sub-pixels displayed in black to be illuminated in white.

Consequently, the correction unit 5 corrects the corresponding three-times magnified image data to permit a red sub-pixel having a higher degree of the luminance contribution between the two sub-pixels displayed in black to be illuminated in white as illustrated in FIG. 4(c). As a result, two sub-pixels including the central sub-pixel are displayed in white.

Accordingly, a sub-pixel having a higher degree of the luminance contribution between two sub-pixels displayed in black is displayed in white, thereby illuminating a total of two sub-pixels in white. This step inhibits the target pixel blurring to a greater degree.

The filtering processing unit 7 is now described. The filtering processing unit 7 filters the corrected (i.e., blur-inhibited) three-times magnified image data that is stored in the three-times magnified image data storage unit 4.

The following discusses coefficients that are used in filtering processing just mentioned above.

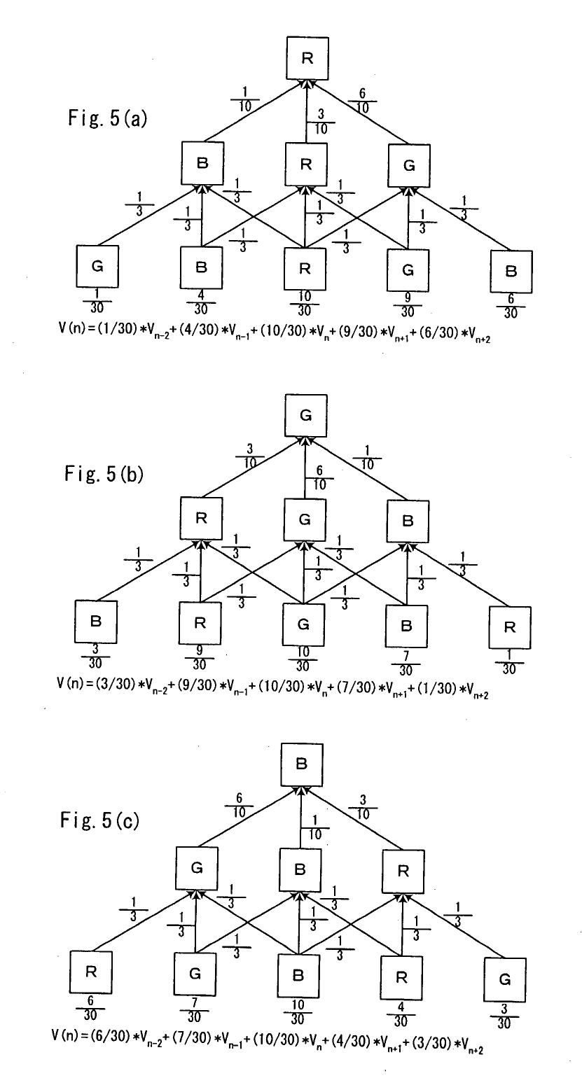

FIG. 5 is an illustration, showing exemplary coefficients used in the filtering processing. FIG. 5(a) is a descriptive illustration, showing exemplary coefficients for a red target sub-pixel. FIG. 5(b) is a descriptive illustration, showing exemplary coefficients for a green target sub-pixel. FIG. 5(c) is a descriptive illustration, showing exemplary coefficients for a blue target sub-pixel.

As illustrated in FIG. 5(a), the following discusses details of coefficients for the red target sub-pixel.

A leftmost green sub-pixel on the bottom stage of FIG. 5(a) has a coefficient of 1/30. A rightward adjacent blue sub-pixel next to the green sub-pixel has a coefficient of 4/30. A rightward adjacent red sub-pixel (a target sub-pixel) next to the blue sub-pixel has a coefficient of 10/30. A rightward adjacent green sub-pixel next to the red target sub-pixel has a coefficient of 9/30. A rightmost blue sub-pixel has a coefficient of 6/30.

A red target sub-pixel has, after filtering processing, a luminance value V(n) determined on the basis of the equation: V(n)=(1/30)*Vn−2+(4/30)*Vn−1+(10/30)*Vn+(9/30)*Vn+1+(6/30)*Vn+2.

Turning now to FIG. 5(b), the following discusses details of coefficients for the green target sub-pixel.

A leftmost blue sub-pixel on the bottom stage of FIG. 5(b) has a coefficient of 3/30. A rightward adjacent red sub-pixel next to the blue sub-pixel has a coefficient of 9/30. A rightward adjacent green sub-pixel (a target sub-pixel) next to the red sub-pixel has a coefficient of 10/30. A rightward adjacent blue sub-pixel next to the green target sub-pixel has a coefficient of 7/30. A rightmost red sub-pixel has a coefficient of 1/30.

A green target pixel has, after filtering processing, a luminance value V(n) determined on the basis of the equation: V(n)=(3/30)*Vn−2+(9/30)*Vn−1+(10/30)*Vn+(7/30)*Vn+1+(1/30)*Vn+2.

Referring now to FIG. 5(c), the following discusses details of coefficients for the blue target sub-pixel.

A leftmost red sub-pixel on the bottom stage of FIG. 5(c) has a coefficient of 6/30. A rightward adjacent green sub-pixel next to the red sub-pixel has a coefficient of 7/30. A rightward adjacent blue sub-pixel (a target sub-pixel) next to the green sub-pixel has a coefficient of 10/30. A rightward adjacent red sub-pixel next to the blue target sub-pixel has a coefficient of 4/30. A rightmost green sub-pixel has a coefficient of 3/30.

A blue target pixel has, after filtering processing, a luminance value V(n) determined on the basis of the equation: V(n)=(6/30)*Vn−2+(7/30)*Vn−1+(10/30)*Vn+(4/30)*Vn+1+(3/30)*Vn+2.

The character “n” as given above refers to a position of the target sub-pixel. The character “Vn−2” refers to a luminance value of corrected three-times magnified image data to be allocated to the leftmost sub-pixel that is positioned adjacent to the leftward adjacent sub-pixel next to the target sub-pixel. The character “Vn−1” refers to a luminance value of corrected three-times magnified image data to be allocated to the leftward adjacent sub-pixel next to the target sub-pixel. The character “Vn” refers to a luminance value of corrected three-times magnified image data to be allocated to the target sub-pixel. The character “Vn+1” refers to a luminance value of corrected three-times magnified image data to be allocated to the rightward adjacent sub-pixel next to the target sub-pixel. The character “Vn+2” refers to a luminance value of corrected three-times magnified image data to be allocated to the rightmost sub-pixel that is positioned adjacent to the rightward adjacent sub-pixel next to the target sub-pixel.

The filter result storage unit 8 is now described.

The filtering processing unit 7 may execute an operation using the above coefficients, thereby determining the luminance values V(n)'s of the three sub-pixels RGB, i.e., post-filtering processing RGB values.

The determined three luminance values V(n)'s of the three sub-pixels RGB or the post-filtering processing RGB values may be written to the display image storage unit 9 at corresponding positions thereof

However, such processing involves repeated calculations, resulting in increased loads required for the processing. Accordingly, instead of such calculation-based filtering processing, the filter result storage unit 8 containing filtering processing results in advance may be referenced to provide processing results comparable to those obtained through the calculation-based filtering processing. Details of the filter result storage unit 8 are now described.

The filtering processing unit 7 references corrected three-times magnified image data stored in the three-times magnified image data storage unit 4, and then generates addresses in accordance with an on-off (display) state of each of a total of an m-number of sub-pixels aligned with each other in the first direction about a target pixel that is made up of three sub-pixels RGB. As a result, addresses having different combinations of the m power of two are produced. The addresses having different combinations of the m power of two refer to the-m-power-of-two sets of display states of sub-pixels.

According to the present embodiment, as an example of address generation, sub-pixel “on” (displayed in black) and sub-pixel “off” (displayed in white) are described as numerals “1” and “0”, respectively.

The target pixel in the filtering processing unit 7 refers to a pixel that is made up of three sub-pixels, to which the corrected three-times magnified image data stored in the three-times magnified image data storage unit 4 is allocated. In other words, the target pixel in the filtering processing unit 7 is a pixel to be now processed.

The filter result storage unit 8 contains filtering processing results that are obtained by performing an operation in advance for each of the-m-power-of-two sets of display states of sub-pixels.

In this instance, the filter result storage unit 8 contains, in connection with each of the addresses having different combination of the m power of two (i.e., the-m-power-of-two sets of display states of sub-pixels), a set of a luminance value V(n) or filtering processing results for a red sub-pixel defined as a target sub-pixel, a luminance value V(n) or filtering processing results for a green sub-pixel defined as a target sub-pixel, and a luminance value V(n) or filtering processing results for a blue sub-pixel defined as a target sub-pixel.

Since the present embodiment assumes binary image data, the luminance value V(n) or filtering processing results for the red sub-pixel defined as a target sub-pixel, the luminance value V(n) or filtering processing results for the green sub-pixel defined as a target sub-pixel, and the luminance value V(n) or filtering processing results for the blue sub-pixel defined as a target sub-pixel refer to a post-filtering processing R-value, a post-filtering processing G-value, and a post-filtering processing B-value, respectively.

More specifically, the filter result storage unit 8 contains post-filtering processing RGB values of three sub-pixels RGB according to a display state of each of a total of an m-number (m is a natural number) of sub-pixels aligned with each other in the first direction about a pixel that consists of the three sub-pixels RGB.

Pursuant to the present embodiment, the coefficients as illustrated in FIG. 5 are used in the filtering processing. Accordingly, the filtering processing unit 7 generates addresses in accordance with an on-off state of each of a total of seven sub-pixels aligned with each other in the first direction about a target pixel that is made up of three sub-pixels RGB.

In using the coefficients as illustrated in FIG. 5, sub-pixels required to filter a target sub-pixel are a total of five sub-pixels including the target sub-pixel, and sub-pixels required to filter a target pixel that is made up of three sub-pixels RGB are a total of seven sub-pixels aligned with each other in the first direction about the target pixel that consists of the three sub-pixels RGB.

As a result, the filtering processing unit 7 produces addresses having different combinations of the seventh power of two.

Accordingly, the filter result storage unit 8 contains the post-filtering processing RGB values (filtering processing results) in connection with each of the addresses having different combinations of the seventh power of two, i.e., the-seventh-power-of-two sets of display states of sub-pixels.

The filtering processing unit 7 references the filter result storage unit 8, and thereby obtains the post-filtering processing RGB values (filtering processing results) that are connected to each of the generated addresses.

The following discusses a specific example of processing using the filtering processing unit 7.

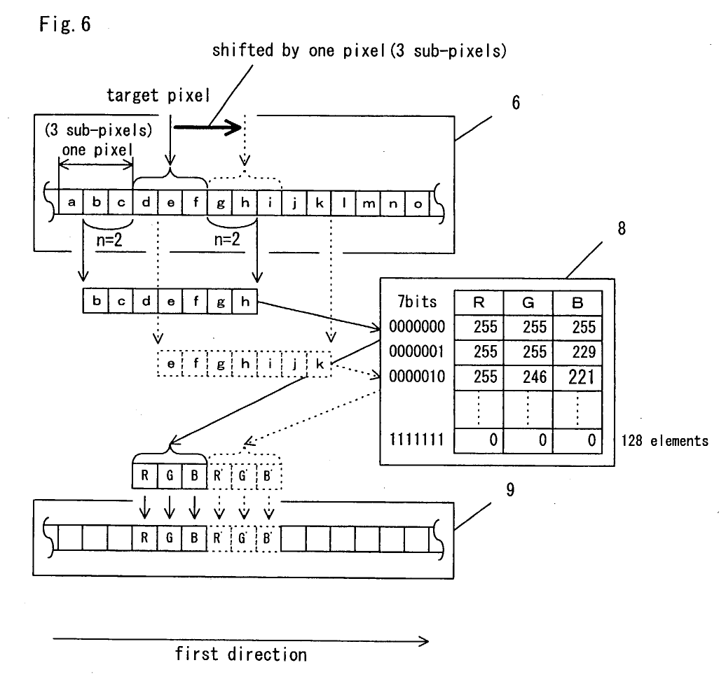

FIG. 6 is an illustration, showing an exemplary example of processing a black character on a white background using the filtering processing unit 7. In FIG. 6, the same components as those of FIG. 1 are identified by the same reference characters.

FIG. 6 assumes that a target pixel (three sub-pixels collectively handled) is, at a certain time, located at a position as shown by an arrow. In FIG. 6, each character such as a, b, c, d, etc. is a piece of corrected (blur-inhibited) three-times magnified image data stored in the three-times magnified image data storage unit 4, and is allocated to a corresponding sub-pixel.

The characters “def” are three-times magnified image data allocated to the target pixel-forming three sub-pixels. The characters “abc” are different pieces of three-times magnified image data allocated to target pixel-forming three sub-pixels that are positioned ahead of the three-times magnified image data “def” in the first direction. The characters “ghi” are further different pieces of three-times magnified image data allocated to target pixel-forming three sub-pixels that are positioned behind the three-times magnified image data “def” in the first direction. The three-times magnified image data “ghi” is followed by yet further different pieces of three-times magnified image data such as “jkl” and so on.

In this instance, the filtering processing unit 7 uses the following: the three-times magnified image data “def” to be allocated to the target pixel at present; the three-times magnified image data “bc” located ahead of the target pixel by a distance equal to two sub-pixels; and the three-times magnified image data “gh” located behind the target pixel by a distance equal to two sub-pixels.

In other words, the filtering processing unit 7 uses the three-times magnified image data to be allocated to a total of seven sub-pixels aligned with each other in the first direction about the target pixel.

The filtering processing unit 7 takes the three-times magnified image data “bcdefgh” out of the three-times magnified image data storage unit 4. The three-times magnified image data “bcdefgh” are to be allocated to the seven sub-pixels. The filtering processing unit 7 converts the three-times magnified image data “bcdefgh” into bits that consist of numerals zero or one.

More specifically, according to the present embodiment, the three-times magnified image data are binary image data, and the three-times magnified image data “bcdefgh” is originally a bit string that consists of the numerals zero or one. Accordingly, the filtering processing unit 7 uses the three-times magnified image data “bcdefgh” without processing the data “bcdefgh”.

As a result, the filtering processing unit 7 generates a binary bit string that has seven digits. The filtering processing unit 7 uses the bit string as a seven-bits address.

As illustrated in FIG. 6, the filter result storage unit 8 contains a table in which each set of post-filtering processing RGB values obtained using the coefficients of FIG. 5 is related to one of the seven-bits addresses having different combinations of the seventh power of two (i.e., one hundred-twenty eight different combinations).

More specifically, the filter result storage unit 8 contains the post-filtering processing RGB values of three sub-pixels RGB obtained using the coefficients of FIG. 5 in accordance with a display state of each of a total of seven sub-pixels aligned with each other in the first direction about a pixel that consists of the three sub-pixels RGB.

The filtering processing unit 7 generates each seven-bits string that extends about a target pixel. The filtering processing unit 7 references the table in the filter result storage unit 8 by taking each of the seven-bits strings as an address, thereby immediately obtaining post-filtering processing RGB values “RGB” of the target pixel.

Subsequently, the filtering processing unit 7 defines a pixel as a target pixel by displacing the pixel by a single pixel, i.e., by three sub-pixels. More specifically, as illustrated in FIG. 6, the target pixel is displaced by a distance of three sub-pixels, as shown by a horizontal arrow of FIG. 6. In such a new target pixel, the subsequent RGB values “RGB” are determined on the basis of three-times magnified image data “efghijk”.

In this way, the filtering processing unit 7 filters all of the corrected three-times magnified image data stored in the three-times magnified image data storage unit 4, while defining every target pixel. As a result, the filtering processing unit 7 obtains all post-filtering processing RGB values.

The post-filtering processing RGB values obtained by the filtering processing unit 7 are written to the display image storage unit 9 at corresponding positions thereof

The display image storage unit 9 of FIG. 1 is now described. The display image storage unit 9 may be, e.g., VRAM (a video random access memory).

As described above, the display image storage unit 9 stores the post-filtering processing RGB values from the filtering processing unit 7.

Next, a flow of processing in the display equipment according to the present embodiment is described with reference to a flowchart.

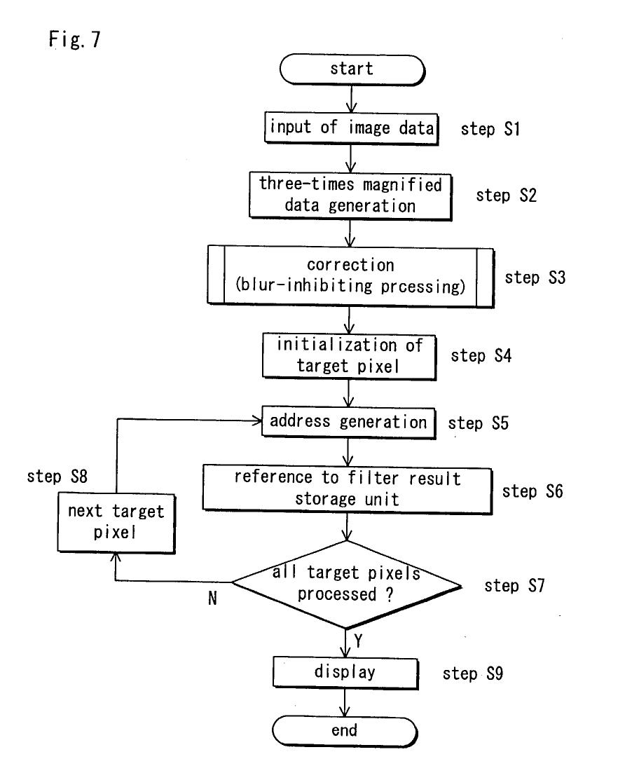

FIG. 7 is a flowchart, illustrating an exemplary flow of processing in the display equipment of FIG. 1. As illustrated in FIG. 7, at step S1, image data is entered into the display equipment. The entered imaged data is placed as original image data into the original image data storage unit 1.

At step S2, the three-times magnified data-generating unit 2 references the reference pattern storage unit 3 in accordance with the original image data stored in the original image data storage unit 1, thereby producing three-times magnified image data.

The three-times magnified data-generating unit 2 places the produced three-times magnified image data into the three-times magnified image data storage unit 4.

At step S3, the correction unit 5 corrects a target pixel that is blurred when the three-times magnified image data contained in the three-times magnified image data storage unit 4 are allocated to sub-pixels of the target pixel. For convenience of description, this correction is here called blur-inhibiting processing. Details of the blur-inhibiting processing are discussed below.

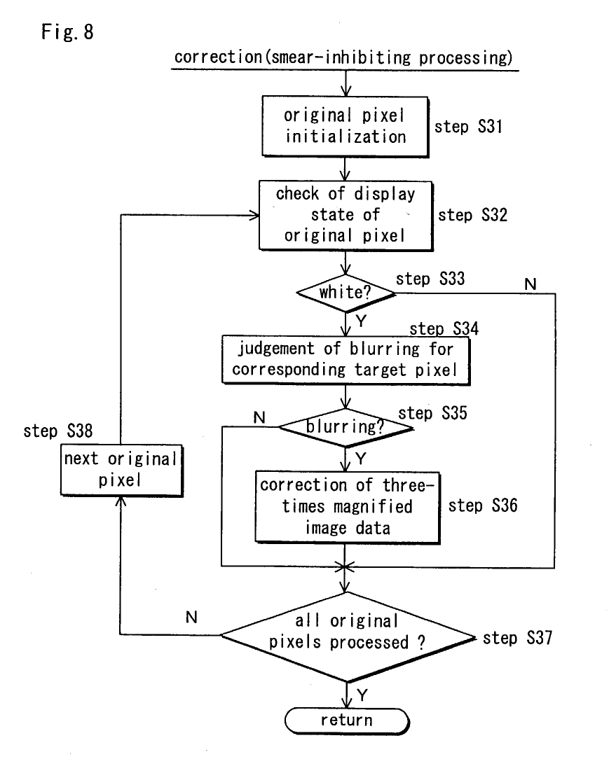

FIG. 8 is a detailed flowchart, illustrating an exemplary flow of correction or blur-inhibiting processing according to step S3 of FIG. 7. As illustrated in FIG. 8, at step S31, the correction unit 5 defines an original pixel at an upper-left initial position as a target pixel. The original pixel is included in the original image stored in the original image data storage unit 1.

At step S32, the correction unit 5 checks the original pixel to see that the original pixel is displayed in either black or white.

When it is found at step S33 that the original pixel is displayed in black, then the correction unit 5 is advanced to step S37. When it is found at step S33 that the original pixel is displayed in white, then the correction unit 5 is advanced to step S34.

At step S34, the correction unit 5 determines whether blurring occurs in the target pixel corresponding to the original pixel displayed in white in the three-times magnified image data contained in the three-times magnified image data storage unit 4. FIG. 2 exhibits the definition of the blurring.

When it is judged at step S35 that the blurring is absent in target pixel corresponding to the original pixel displayed in white, then the correction unit 5 is advanced to step S37. However, when it is judged at step S35 that the blurring is present in the target pixel corresponding to the original pixel displayed in white, then the correction unit 5 is advanced to step S36.

At step S36, the correction unit 5 corrects three-times magnified image data to be allocated to the blurred target pixel.

More specifically, when the original pixel corresponding to the target pixel is displayed in white as illustrated in FIG. 3(a), and when target pixel-forming three sub-pixels are all displayed in black, then the correction unit 5 corrects corresponding three-times magnified image data to allow one of the target pixel-forming three sub-pixels to be displayed in white as illustrated in FIG. 3(c).

When the original pixel corresponding to the target pixel is displayed in white as illustrated in FIG. 4(a), and when only a central sub-pixel of the target pixel-forming three sub-pixels is displayed in white, then the correction unit 5 corrects corresponding three-times magnified image data to allow one of two pixels displayed in black among the target pixel-forming three sub-pixels to be displayed in white. As a result, two sub-pixels including the central sub-pixel are displayed in white as illustrated in FIG. 4(c).

In this instance, when the sub-pixel is to be illuminated in white, a sub-pixel having a greater degree of a luminance contribution is displayed in white.

When it is found at step S37 that processing according to the steps S32 to S36 is not completed for all of the original pixels, then the correction unit 5 is advanced to step S38, at which the next original pixel to be processed is defined as a target pixel.

The correction unit 5 processes the defined target pixel according to the steps S32 to S36.

The correction unit 5 repeats the above processing. When it is found at step S37 that the processing according to the steps S32 to S36 is completed for all of the original pixels, then the correction unit 5 is advanced to step S4 of FIG. 7.

The above correction inhibits the blurring of the target pixel in the three-times magnified image data stored in the three-times magnified image data storage unit 4.

Turning now back to FIG. 7, at step 4, the filtering processing unit 7 defines a pixel at an upper-left initial position as a target pixel. The target pixel is included in the corrected three-times magnified image data stored in the three-times magnified image data storage unit 4.

At step S5, the filtering processing unit 7 generates addresses in accordance with an on-off state of each of a total of seven sub-pixels aligned with each other in the first direction about the target pixel that consists of three sub-pixels RGB.

At step S6, the filtering processing unit 7 references the filter result storage unit 8, and obtains post-filtering processing RGB values (filtering processing results) that are related to each of the generated addresses.

When it is found at step S7 that the processing according to steps S5 and S6 is not completed for all of the target pixels, then the filtering processing unit 7 is advanced to step S8, at which the next pixel to be processed is defined as a target pixel.

The filtering processing unit 7 processes the defined target pixel in accordance with steps S5 and S6.

The filtering processing unit 7 repeats the above processing. When it is found at step S7 that the processing according to steps S5 and S6 is completed for all of the target pixels, then the filtering processing unit 7 is advanced to step S9.

The post-filtering processing RGB values obtained at step S6 using the filtering processing unit 7 are written to the display image storage unit 9.

At step S9, the RGB values written to the display image storage unit 9 are allocated to the display device 10 at corresponding pixels thereof, and are thereby displayed on the display device 10.

In this instance, since each pixel is made up of three sub-pixels RGB (three light-emitting elements RGB), the RGB values are allocated to the three sub-pixels RGB (the three light-emitting elements RGB), respectively.

As described above, the three-times magnified image data contained in the three-times magnified storage unit 4 are corrected as blur-inhibiting processing using the correction unit 5, and are filtered using the filtering processing unit 7. As a result, a three-times magnified precision image (a per sub-pixel image) is displayed on the display device 10.

As detailed above, it is judged according to the present embodiment that a displayed target pixel is blurred, either when an original pixel corresponding to a target pixel is in a first display state (i.e., white according to the present embodiment) and target pixel-forming three sub-pixels are in a second display state (i.e., black according to the present embodiment) as illustrated in FIG. 2(a), or when the original pixel corresponding to the target pixel is in the first display state (i.e., white according to the present embodiment) and only a central sub-pixel of the target pixel-forming three sub-pixels is in the first display state (i.e., white according to the present embodiment) as illustrated in FIG. 2(b).

In this instance, when the background is displayed by sub-pixels that are in the first state (i.e., white according to the present embodiment) and an object (a character, a symbol, a figure, or a combination thereof) is displayed by sub-pixels that are in the second state (i.e., black according to the present embodiment), then it is judged that the target pixel that represents the object is blurred. As a result, it is judged that a space between object lines is blurred.

To solve the above, an increased number of the sub-pixels in the first display state (i.e., white according to the present embodiment) for representing the background are provided in the target pixel. This step inhibits the blurring between the object lines, thereby providing an explicitly displayed object.

The inhibited blurring as described above provides the explicitly displayed object, even after corrected three-times magnified image data are subsequently filtered:

According to the present embodiment, in order to suppress the blurring as defined by FIG. 2(a), a green sub-pixel having the greatest level of a luminance contribution among the three sub-pixels is rendered in the first display state (i.e., white according to the present embodiment). In order to suppress the blurring as defined by FIG. 2(b), a red sub-pixel having a greater level of the luminance contribution between two sub-pixels except for the central sub-pixel among the three sub-pixels is rendered in the first display state (i.e., white according to the present embodiment). As a result, a total of two sub-pixels among the three sub-pixels are rendered in the first display state (i.e., white according to the present embodiment).

The above step suppresses the blurring between the object lines to a further degree, thereby providing a further explicitly displayed object.

The present embodiment assumes that a black object on a white background is displayed. Alternatively, the present embodiment is susceptible to any color combination for the object and background. For example, a white object on a black background may be displayed.

A method for generating the three-times magnified image data using the three-times magnified image data-generating unit 2 is not limited to the above-described method. The present embodiment is applicable to a case where a target pixel is blurred as defined in FIG. 2 when the resulting three-times magnified image data are allocated to sub-pixels of the target pixel.

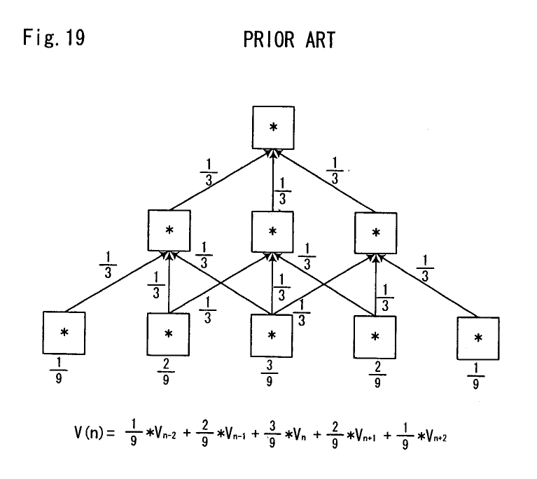

The coefficients used in the filtering processing are not limited to those as illustrated in FIG. 5. According to the present embodiment, any coefficient may be used. For example, coefficients as illustrated in FIG. 19 may be used according to the present embodiment.

According to the present embodiment, calculation-based filtering processing as well as the above-described filtering proceeding using the filter result storage unit 8 is applicable.

According to the present embodiment, the sub-pixels are aligned with each other in the order of RGB. Alternatively, the sub-pixels may be arranged in the order of BGR according to the present embodiment.

The correction unit 5 may practice the blur-inhibiting processing when the three-times magnified image data-generating unit 2 produces the three-times magnified image data.

However, in order to judge the occurrence of blurring when the three-times magnified image data is generated, the three-times magnified image data-generating unit 2 must extract at least a bitmap pattern that consists of a total of a (5*5−1) number of pixels. The total of a (5*5−1) number of pixels excludes a target original pixel from a rectangular pattern that consists of the target original pixel and neighboring pixels about the target original pixel. The bitmap pattern includes different combinations of the twenty-fourth power of two.

This means that the reference pattern storage unit 3 must contain a reference pattern that includes different combinations of the twenty-fourth power of two. This is impractical because a memory having a huge volume must be used.

(Embodiment 2)

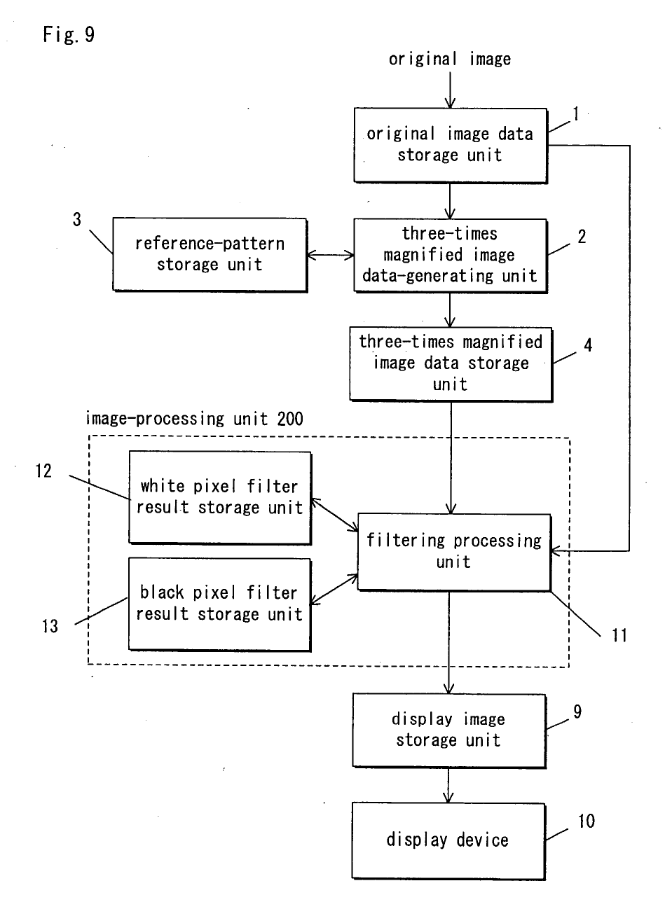

FIG. 9 is a block diagram, illustrating exemplary display equipment according to a second embodiment of the present invention. As illustrated in FIG. 9, the display equipment includes an original image data storage unit 1, a three-times magnified image data-generating unit 2, a reference pattern storage unit 3, a three-times magnified image data storage unit 4, an image-processing unit 200, a display image storage unit 9, and a display device 10.

The image-processing unit 200 includes a filtering processing unit 11, a white pixel filter result storage unit 12, and a black pixel filter result storage unit 13.

In FIG. 9, the same components as those of FIG. 1 are identified by the same reference characters, and descriptions related thereto are omitted.

The following assumes that original image data contained in the original image data storage unit 1 is binary raster image data that represents a character displayed in black on a white background.

The image-processing unit 200 is now described. When an original pixel corresponding to a target pixel is displayed in white, then the filtering processing unit 11 references the white pixel-filter result storage unit 12, and filters three-times magnified image data stored in the three-times magnified image data storage unit 4.

When the original pixel corresponding to the target pixel is displayed in black, then the filtering processing unit 11 references the black pixel-filter result storage unit 13, and filters three-times magnified image data stored in the three-times magnified image data storage unit 4.

The target pixel as mentioned above refers to a pixel that is made up of three sub-pixels, to which the three-times magnified image data stored in the three-times magnified image data storage unit 4 are allocated. In other words, the target pixel as mentioned above is a pixel to be now processed.

The original pixel as mentioned above refers to a pixel, to which original image data stored in the original image data storage unit 1 is allocated.

A detailed flow of processing using the image-processing unit 200 is now described with reference to the drawings.

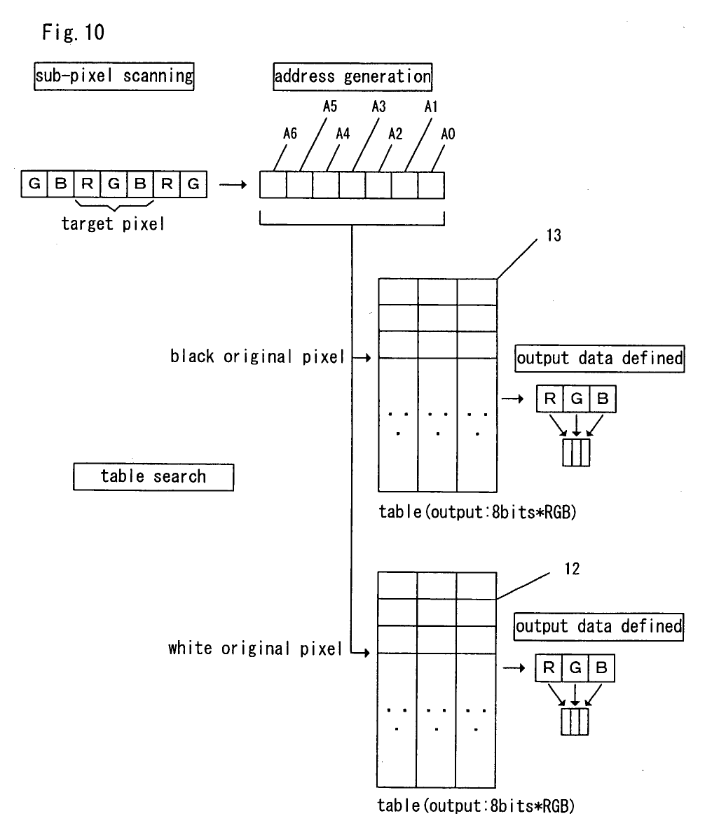

FIG. 10 is a descriptive illustration, showing exemplary detailed processing using the image-processing unit 200.

According to the present embodiment, filtering processing is practiced using coefficients as illustrated in FIG. 5.

As illustrated in FIG. 10, the filtering processing unit 11 scans a total of seven sub-pixels aligned with each other in the first direction about a target pixel that consists of three sub-pixels RGB. The filtering processing unit II generates addresses A0 to A6 in accordance with an on-off state (a display state) of each of the sub-pixels. As a result, the filtering processing unit 11 produces addresses having different combinations of the seventh power of two. In other words, such addresses refer to the-seventh-power-of-two sets of display states of the sub-pixels.

According to the present embodiment, as an example of address generation, sub-pixel “on” (displayed in black) and sub-pixel “off” (displayed in white) are expressed as numerals “1” and “0”, respectively.

The filtering processing unit 11 generates the addresses in a manner substantially similar to the way in which the filtering processing unit 7 of FIG. 1 produces addresses, except that the filtering processing unit 11 according to the present embodiment produces the addresses on the basis of the three-times magnified image data stored in the three-times magnified image data storage unit 4, while the filtering processing unit 7 of FIG. 1 generates the addresses on the basis of corrected three-times magnified image data stored in the three-times magnified image data storage unit 4.

When the original pixel corresponding to the target pixel is displayed in black, then the filtering processing unit 11 references the black pixel filter result storage unit 13 to practice the filtering processing.

The black pixel filter result storage unit 13 contains filtering processing results that are obtained by executing an operation in advance using the coefficients of FIG. 5 for each of the-seventh-power-of-two sets of display states of the sub-pixels.

In this instance, the black pixel-filtering processing results storage unit 13 contains, in connection with each of the addresses having different combinations of the seventh power of two (i.e., the-seventh-power-of-two sets of display states of the sub-pixels), a set of a luminance value V(n) or filtering processing results for a red sub-pixel defined as a target sub-pixel, a luminance value V(n) or filtering processing results for a green sub-pixels defined as a target pixel, and a luminance value V(n) or filtering processing results for a blue sub-pixel defined as a target pixel.

The present embodiment illustrates the binary image data, and the luminance value V(n) or the filtering processing results for the red pixel defined as a target pixel is a post-filtering processing R-value. Similarly, the luminance value V(n) or the filtering processing results for the green sub-pixel defined as a target pixel is a post-filtering processing G-value. The luminance value V(n) or the filtering processing results for the blue sub-pixel defined as a target pixel is a post-filtering processing B-value.

The black pixel filter result storage unit 13 is similar to a filter result storage unit 8 of FIG. 1. The black pixel filter result storage unit 13 contains post-filtering processing RGB values of three sub-pixels RGB obtained using the coefficients of FIG. 5 in accordance with a display state of each of a total of seven sub-pixels aligned with each other in the first direction about a pixel that is made up of the three sub-pixels RGB.

As described above, the black pixel filter result storage unit 13 contains a table in which the post-filtering processing RGB values based on the coefficients of FIG. 5 are related to each of seven-bits addresses having different combinations of the seventh power of two, or rather one-hundred twenty eight different combinations.

When the original pixel corresponding to the target pixel is displayed in black, then the filtering processing unit 11 generates each seven-bits string that extends about the target pixel. The filtering processing unit 11 references the table in the black pixel filter result storage unit 13 by taking each of the seven-bits strings as an address, thereby immediately obtaining the post-filtering processing RGB values of the target pixel. The RGB values are written to the display image storage unit 9 at corresponding positions thereof

As illustrated in FIG. 10, when the original pixel corresponding to the target pixel is displayed in white, then the filtering processing unit 11 references the white pixel filter result storage unit 12 to execute the filtering processing.

The white pixel filter result storage unit 12 contains filtering processing results that are obtained by performing an operation in advance using the coefficients of FIG. 5 for each of the-seventh-power-of-two sets of displayed states of the sub-pixels.

In short, the white pixel filter result storage unit 12 contains the post-filtering processing RGB values of three sub-pixels RGB obtained using the coefficients of FIG. 5 in accordance with a display state of each of a total of seven sub-pixels aligned in the first direction about a pixel that is made up of the three sub-pixels RGB.

In this regard, the white pixel filter result storage unit 12 is similar to the black pixel filter result storage unit 13. However, the following discusses big differences between the white and black pixel filter result storage units 12 and 13.

The addresses produced using the filtering processing unit 11 when the target pixel-forming three sub-pixels RGB are all displayed in black are related to filtering processing results for a pixel that consists of a sub-pixel displayed in white and the remaining two sub-pixels displayed in black. The white pixel filter result storage unit 12 contains the filtering processing results.

Assuming that the filtering processing unit 11 produces an address **111** when the original pixel is displayed in white, blurring as defined by FIG. 2(a) occur. In this instance, filtering processing results for, e.g., address 1110111, are put into the white pixel filter result storage unit 12 as the address **111**.

The numerals “1” and “0” denote a sub-pixel displayed in black and that displayed in white, respectively. The symbol “*” denotes “1” or “0”, i.e. a sub-pixel displayed in black or that displayed in white.

The addresses produced using the filtering processing unit 11 when only a central sub-pixel among the target pixel-forming three sub-pixels RGB is displayed in white are related to filtering processing results for a pixel that is made up of two sub-pixels including a central sub-pixel, which are all displayed in white, and the remaining one sub-pixel displayed in black. The white pixel filter result storage unit 12 contains the filtering processing results.

Assuming that the filtering processing unit 11 produces an address **101** when the original pixel is displayed in white, blurring as defined by FIG. 2(b) occurs. In this instance, filtering processing results for, e.g., address 1100111, are placed into the white pixel filter result storage unit 12 as the address **101**.

The numerals “1” and “0” denote a sub-pixel displayed in black and that displayed in white, respectively. The symbol “*” denote an arbitrary numeral.

As described above, the table having the seven-bits addresses related to the filtering processing results based on the coefficients of FIG. 5 is provided. The seven-bits addresses include different combinations of the seventh power of two, i.e., one hundred and twenty eight different combinations.

In the table, the address **111*** is related to the filtering processing results for the address **101**. The address **101** is related to the filtering processing results for the address **001**. The white pixel filter result storage unit 12 contains such a table.

In view of the above, the following discusses a conclusion.

When an original pixel corresponding to a target pixel is white and when an address is **111**, then the target pixel is blurred as defined by FIG. 2(a).

In this case, the filtering processing results related to the address **11** are defined as filtering processing results for a pixel including a sub-pixel displayed in white, or rather as filtering processing results for the address **101**.

This feature inhibits the target pixel blurring as defined by FIG. 2(a). In addition, this feature practices the filtering processing, while suppressing the blurring.

In particular, the filtering processing results related to the address **111** are defined as filtering processing results for a pixel including a green sub-pixel (the green sub-pixel having the greatest degree of a luminance contribution) displayed in white, or rather as filtering processing results for the address **101**.

This feature suppresses the target pixel blurring to a greater extent.

As seen from FIG. 10, sub-pixels in each pixel are aligned in the order of RGB. The three primary colors RGB have a luminance contribution in the ratio of nearly 3:6:1, respectively.

When an original pixel corresponding to a target pixel is white and when an address is **101**, then the original pixel is blurred as defined by FIG. 2(b).

In this case, the filtering processing results related to the address **101** are defined as filtering processing results for a pixel including two sub-pixels (the two sub-pixels including a central sub-pixel) displayed in white, or rather as filtering processing results for the address **001**.

This feature inhibits the target pixel blurring as defined by FIG. 2(b). In addition, this feature practices the filtering processing, while suppressing the blurring.

In particular, the filtering processing results related to the address **101** are defined as filtering processing results for a pixel including a central sub-pixel displayed in white and a red sub-pixel displayed in white (the red sub-pixel having a greater degree of the luminance contribution than a blue sub-pixel does), or rather as filtering processing results for the address **001**.

This feature suppresses the target pixel blurring to a greater extent.

As described above, the filtering processing unit 11 produces each seven-bit string that extends about a target pixel, when the original pixel corresponding to the target pixel is displayed in white. The filtering processing unit 11 references the table inside the white pixel filter result storage unit 12 by defining each of the seven-bit strings as an address. As a result, the filtering processing unit 11 immediately obtains the post-filtering processing RGB values of the blur-inhibited target pixel. The post-filtering processing RGB values are written to the display image storage unit 9 at corresponding positions thereof.

A flow of processing using the display equipment of FIG. 9 is now described with reference to a flowchart.

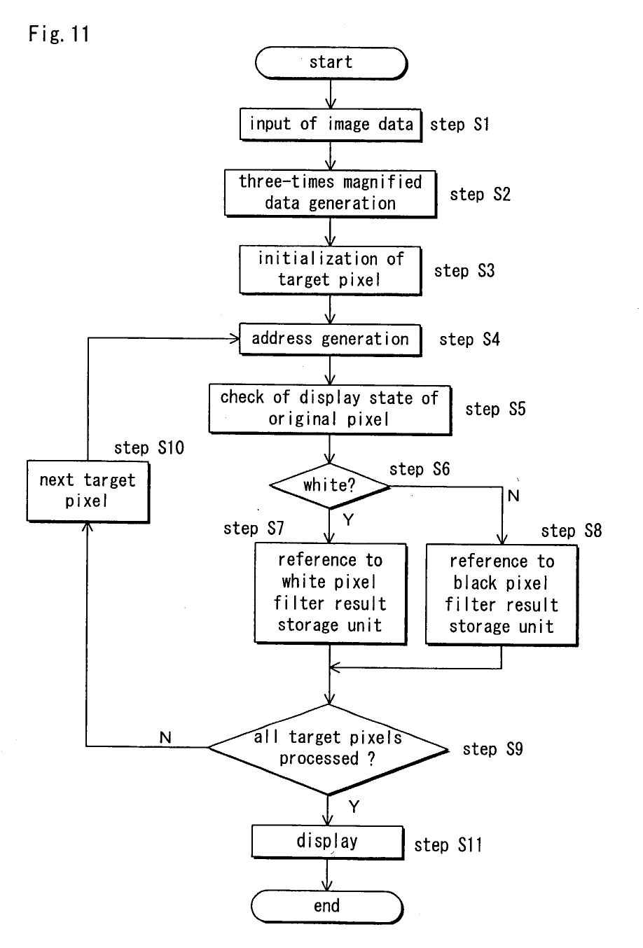

FIG. 11 is a flowchart, illustrating an exemplary flow of processing using the display equipment of FIG. 9. As illustrated in FIG. 11, at step S1, image data is entered into the display equipment. The entered image data is placed as original image data into the original image data storage unit 1.

As step S2, the three-times magnified image data-generating unit 2 references the reference pattern storage unit 3 in accordance with the original image data contained in the original image data storage unit 1, and produces three-times magnified image data.

The three-times magnified image data-generating unit 2 puts the produced three-times magnified image data into the three-times magnified image data storage unit 4.

At step S3, the filtering processing unit 11 defines a pixel at an upper-left initial position as a target pixel in the three-times magnified image data stored in the three-times magnified image data storage unit 4.

At step S4, the filtering processing unit 11 generates addresses in accordance with an on-off state of each of a total of seven sub-pixels aligned with each other in the first direction about the target pixel that is made up of three sub-pixels RGB.

At step S5, the filtering processing unit II checks an original pixel corresponding to the target pixel to see whether the original pixel is displayed in either white or black.

When it is determined at step S6 that the original pixel corresponding to the target pixel is displayed in white, then the filtering processing unit II is advanced to step S7. The filtering processing unit 11 is moved to step S8 when it is determined at step S6 that the original pixel correspond to the target pixel is displayed in black.

At step S7, the filtering processing unit 11 references the white pixel filter result storage unit 12, and obtains post-filtering processing RGB values (filtering processing results) according to each of the generated addresses.

At step S7, the blur-inhibiting processing as well as the filtering processing is executed.

At step S8, the filtering processing unit II references the black pixel filter result storage unit 13, and obtains post-filtering processing RGB values (filtering processing results) according to each of the generated addresses.

At step S8, only the filtering processing is carried out.

When it is determined at step S9 that the entire processing according to steps S4 to S8 is not terminated for all of the target pixels, then filtering processing unit 11 is advanced to step S10, at which the next pixel is defined as a target pixel.

The filtering processing unit 11 processes the defined target pixel according to the steps S4 to S8.

The filtering processing unit 11 repeats the above processing, and is advanced to step S11 when it is determined at step S9 that the entire processing according to step S4 to S8 are completed for all of the target pixels.

The post-filtering processing RGB values are written to the display image storage unit 9.

At step S11, the RGB values written to the display image storage unit 9 are allocated to the display device 10 at corresponding pixels thereof, and are thereby displayed on the display device 10.

In this instance, since a pixel is made up of three sub-pixels RGB (three light-emitting elements RGB), the RGB values are allocated to the three sub-pixels RGB (the three light-emitting elements RGB), respectively.

In this way, the three-times magnified image data contained in the three-times magnified image data storage unit 4 experiences the blur-inhibiting processing and the filtering processing, with the result that a three-times magnified precision image (a per sub-pixel image) is displayed on the display device 10.

As detailed above, according to the present embodiment, a displayed target pixel is judged to be blurred either when an original pixel corresponding to the target pixel is in a first display state (i.e., white according to the present embodiment) and target pixel-forming three sub-pixels are in a second display state (i.e., black according the present embodiment) as illustrated in FIG. 2(a), or when the original pixel corresponding to the target pixel is in the first display state (i.e., white according to the present embodiment) and only a central sub-pixel among the target pixel-forming three sub-pixels is in the first display state (i.e., white according to the present embodiment) as illustrated in FIG. 2(b).

In this instance, when sub-pixels in the first display state (i.e., white according to the present embodiment) displays the background and sub-pixels in the second display state (i.e., black according to the present embodiment) displays an object (a character, a symbol, a figure, or a combination thereof), then it is judged that the target pixels that represent the object are blurred, and consequently that a space between object lines is blurred.

Accordingly, filtering processing results for a pixel that includes a larger number of the background-displaying sub-pixels in the first display state (i.e., white according to the present embodiment) than the number of the target pixel judged to be blurred are previously placed into a first filter result storage unit (i.e., the white pixel filter result storage unit 12 according to the present embodiment) as filtering processing results for the target pixel that is judged as blurred.

Consequently, the filtering processing results for the pixel that includes a larger number of the background-displaying sub-pixels in the first display state (i.e., white according to the present embodiment) than the number of the target pixel judged to be blurred can be obtained from the first filter result storage unit (i.e., the white pixel filter result storage unit 12 according to the present embodiment) as filtering processing results for the target pixel that is judged as blurred.

As a result, blurring between object lines is inhibited, and an explicit object can be displayed. In addition, the blur-inhibiting processing and the filtering processing are executable in parallel, and high-speed processing is achievable.

Furthermore, simply referencing the first filter result storage unit (i.e., the white pixel filter result storage unit 12) makes it feasible to perform the blur-inhibiting processing and the filtering processing at one time, and high-speed processing is achievable.

According to the present embodiment, when the target pixel is blurred as defined by FIG. 2(a), filtering processing results for a pixel that includes a green sub-pixel (the green sub-pixel having the greatest degree of the luminance contribution among three sub-pixels) in the first display state (i.e., white according to the present embodiment) and the remaining two sub-pixels in the second display state (i.e., black according to the present embodiment) are obtainable from the first filter result storage unit (i.e., the white pixel filter result storage unit 12).

When the target pixel is blurred as defined by FIG. 2(b), filtering processing results for a pixel that includes a central green sub-pixel in the first display state (i.e., white according to the present embodiment), one of the remaining two sub-pixels, which is a red sub-pixel (the red sub-pixel having a greater level of the luminance contribution between the remaining two sub-pixels) in the first display state (i.e., white according to the present embodiment), and the remainder in the second display state (i.e., black according to the present embodiment) are obtainable from the first filter result storage unit (i.e., the white pixel filter result storage unit 12).

This feature realizes further suppressed blurring between the object lines, and a more explicit object can be displayed.

The above description assumes that a black object on a white background is illustrated. Alternatively, the background and the object may be displayed in converse color because an object of any different colors on a background of any different colors may be illustrated according to the present embodiment.

A method for generating the three-times magnified image data using the three-times magnified image data-generating unit 2 is not limited to the above. The present embodiment is applicable to a case where a target pixel is blurred as defined in FIG. 2 when the resulting three-times magnified image data are allocated to sub-pixels of the target pixel.

Coefficients used in the filtering processing are not limited to those as illustrated in FIG. 5. According to the present embodiment, any coefficient may be used. For example, coefficients as illustrated in FIG. 19 may be used according to the present embodiment.

Although the present embodiment assumes that the sub-pixels are aligned in the order of RGB, the sub-pixels may alternatively be aligned in the order of BGR according to the present embodiment.

(Embodiment 3)

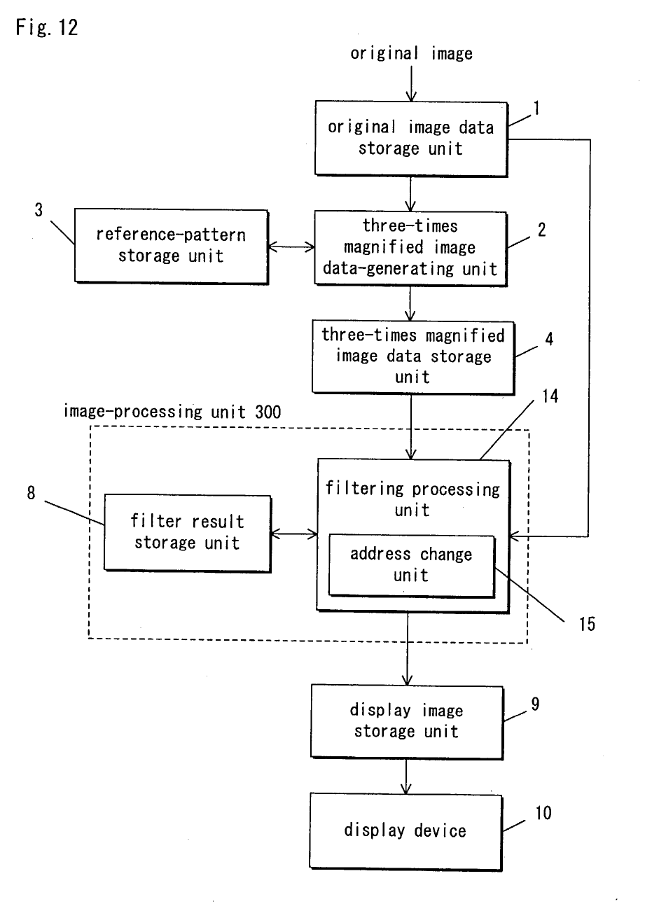

FIG. 12 is a block diagram, illustrating exemplary display equipment according to a third embodiment of the present invention. As illustrated in FIG. 12, the display equipment includes an original image data storage unit 1, a three-times magnified image data-generating unit 2, a reference pattern storage unit 3, a three-times magnified image data storage unit 4, an image-processing unit 300, a display image storage unit 9, and a display device 10.

The image-processing unit 300 includes a filtering processing unit 14 and a filter result storage unit 8. The filtering processing unit 14 includes an address change unit 15.

In FIG. 12, the same components as those of FIG. 1 are identified by the same reference characters, and descriptions related thereto are omitted.

The following assumes that original image data contained in the original image data storage unit 1 is binary raster image data that represents a character displayed in black on a white background.

The image-processing unit 300 is now described. According to the present embodiment, coefficients as illustrated in FIG. 5 are used in filtering processing.

The filtering processing unit 11 scans a total of seven sub-pixels aligned with each other in the first direction about a target pixel that is made up of three sub-pixels RGB. The filtering processing unit 11 generates seven-bits addresses in accordance with an on-off state (a display state) of each of the sub-pixels. As a result, the filtering processing unit 11 produces addresses having different combinations of the seventh power of two.

According to the present embodiment, as an example of address generation, sub-pixel “on” (displayed in black) and sub-pixel “off” (displayed in white) are expressed as numerals “1” and “0”, respectively.

The filtering processing unit 14 generates the addresses in a manner substantially similar to the way in which the filtering processing unit 7 of FIG. 1 produces addresses, except that the filtering processing unit 14 according to the present embodiment produces the addresses on the basis of the three-times magnified image data stored in the three-times magnified image data storage unit 4, while the filtering processing unit 7 of FIG. 1 generates the addresses on the basis of corrected three-times magnified image data stored in the three-times magnified image data storage unit 4.

However, when the target pixel is blurred as defined in FIGS. 2(a) and 2(b), then the address change unit 15 changes the addresses to predetermined addresses. Details of such a change are discussed later.

The filtering processing unit 11 obtains filtering processing results from the filter result, storage unit 8 in accordance with each of the generated seven-bits addresses.

The filter result storage unit 8 contains the filtering processing results that are obtained by performing an operation in advance using the coefficients of FIG. 5 for each of the-seventh-power-of-two sets of display states of sub-pixels.

More specifically, the pixel filter result storage unit 8 contains post-filtering processing RGB values of the three sub-pixels RGB obtained using the coefficients of FIG. 5 in accordance with a display state of each of a total of seven sub-pixels aligned with each other in the first direction about a pixel that is made up of the three sub-pixels RGB.

In this regard, the filter result storage unit 8 is substantially similar to a black pixel filter result storage unit 13 of FIG. 9.

The filter result storage unit 8 contains a table in which the post-filtering processing RGB values based on the coefficients of FIG. 5 are related to each of the seven-bits addresses having different combinations of the seventh power of two, or rather one-hundred twenty eight different combinations.

The filtering processing unit 11 generates each seven-bits string that extends about the target pixel. The filtering processing unit 11 references the table in the filter result storage unit 8 by taking each of the seven-bits strings as an address, and thereby immediately obtains the post-filtering processing RGB values of the target pixel. The RGB values are written to the display image storage unit 9 at corresponding positions thereof

The following discusses how the address change unit 15 changes the addresses.

As illustrated in FIG. 2(a), assuming that an original pixel corresponding to a target pixel is displayed in white, and that target pixel-forming three sub-pixels are all displayed in black when three-times magnified image data contained in the three-times magnified image data storage unit 4 are allocated to the target pixel, then the filtering processing unit 14 judges that the displayed target pixel is blurred.

As illustrated in FIG. 2(b), assuming that the original pixel corresponding to the target pixel is displayed in white, and that only a central sub-pixel among the target pixel-forming three sub-pixels is displayed in white when the three-times magnified image data contained in the three-times magnified image data storage unit 4 are allocated to the target pixel, then the filtering processing unit 14 judges that the displayed target pixel is blurred.

The target pixel as mentioned above refers to a pixel that is made up of three sub-pixels, to which the three-times magnified image data stored in the three-times magnified image data storage unit 4 are allocated. In other words, the target pixel as given above refers to a pixel to be now processed.

The original image as given above refers to a pixel, to which original image data stored in the original image data storage unit 1 are allocated.

When the target pixel is blurred as defined in FIG. 2(a), then the address change unit 15 changes a target pixel-based address to an address that extends about a pixel made up of a sub-pixel displayed in white and the remaining two sub-pixels displayed in black.

Consequently, the filtering processing unit 14 can obtain, from the filter result storage unit 8, post-filtering processing RGB values of the pixel including the sub-pixel displayed in white and the remaining two sub-pixels displayed in black when the target pixel is blurred as defined in FIG. 2(a).

When the target pixel is blurred as defined in FIG. 2(a), and when the filtering processing unit 14 produces an address **111**, then the address change unit 15 changes an address **111** to, e.g., an address 1110111.

The numerals “1” and “0” as given above denote a sub-pixel displayed in black and that displayed in white, respectively. The symbol “*” denotes an arbitrary numeral.

In the above example, when the target pixel is blurred as defined in FIG. 2(a), then the filtering processing unit 14 obtains post-filtering processing RGB values according to the address 1110111 from the filter result storage unit 8.

As a result, when the target pixel is blurred as defined in FIG. 2(a), then blurring can be inhibited, while filtering processing is carried out.

When a target pixel is blurred as defined in FIG. 2(b), then the address change unit 15 changes a target pixel-based address to an address that extends about a pixel made up of three sub-pixels in which two pixels including a central sub-pixel are displayed in white.

Consequently, when the target pixel is blurred as defined in FIG. 2(b), then the filtering processing unit 14 can obtain, from the filter result storage unit 8, post-filtering processing RGB values of the pixel made up of the three sub-pixels in which the two sub-pixels including the central sub-pixel are displayed in white.

When the target pixel is blurred as defined in FIG. 2(b), and when the filtering processing unit 14 produces an address **101**, then the address change unit 15 changes the address **101** to, e.g., an address 1100111.

The numerals “1” and “0” as given above denote a sub-pixel displayed in black and that displayed in white, respectively. The symbol “*” denotes an arbitrary numeral.

In the above example, when the target pixel is blurred as defined in FIG. 2(b), then the filtering processing unit 14 obtains post-filtering processing RGB values according to the address 1100111 from the filter result storage unit 8.

As a result, when the target pixel is blurred as defined in FIG. 2(b), then blurring can be inhibited, while filtering processing is carried out.

Only when the target pixel is blurred as defined in FIG. 2(a) or (b), then the address change unit 15 changes the target pixel-based address. Unless otherwise, the address change unit 15 never changes the target pixel-based address.

As described above, the address change unit 15 changes the address **111** of the blurred target pixel as defined in FIG. 2(a) to the address **101**. The address change unit 15 changes the address **101** of the blurred target pixel as defined in FIG. 2(b) to the address **001**.

The filtering processing unit 14 obtains, from the filter result storage unit 8, the post-filtering processing RGB values that are related to each of the changed addresses.

In view of the above, the following discusses a conclusion.

A target pixel is blurred as defined by FIG. 2(a) when an original pixel corresponding to the target pixel is white and when an address is **111**.

Consequently, the address **111** are changed to the address **101** that extends about a pixel including a sub-pixel displayed in white.

This feature inhibits the target pixel blurring as defined by FIG. 2(a). In addition, this feature performs the filtering processing, while suppressing the blurring.

In particular, the address **111** is changed to the address **101** that extends about a pixel including a green sub-pixel displayed in white (the green sub-pixel having the greatest degree of luminance contribution).

This feature suppresses the target pixel blurring to a greater extent.

Sub-pixels in each pixel are aligned in the order of GBRGBRG. Each of sub-pixels corresponds to a bit of an address. The three primary colors RGB have a luminance contribution in the ratio of nearly 3:6:1, respectively.

An original pixel is blurred as defined by FIG. 2(b) when an original pixel corresponding to the target pixel is white and when an address is **101**.

The address **101** is changed to the address **001** that extends about a pixel that consists of three sub-pixels in which two sub-pixels including a central sub-pixel are displayed in white.

This feature inhibits the target pixel blurring as defined by FIG. 2(b). In addition, this feature performs the filtering processing, while suppressing the blurring.

In particular, the address **101** is changed to the address **101** that extends about a pixel including a red sub-pixel displayed in white (the red sub-pixel having a greater degree of the luminance contribution than a blue sub-pixel does).

This feature suppresses the target pixel blurring to a greater extent. The sub-pixels are aligned with each other in a manner just mentioned above.

A flow of processing using the display equipment as illustrated in FIG. 12 is now described with reference to a flowchart.

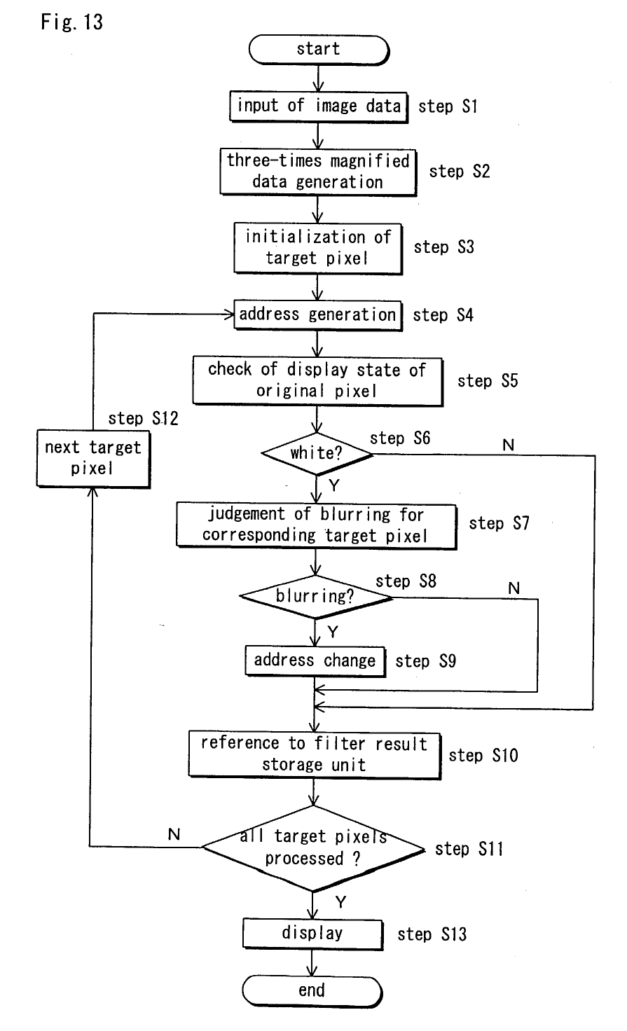

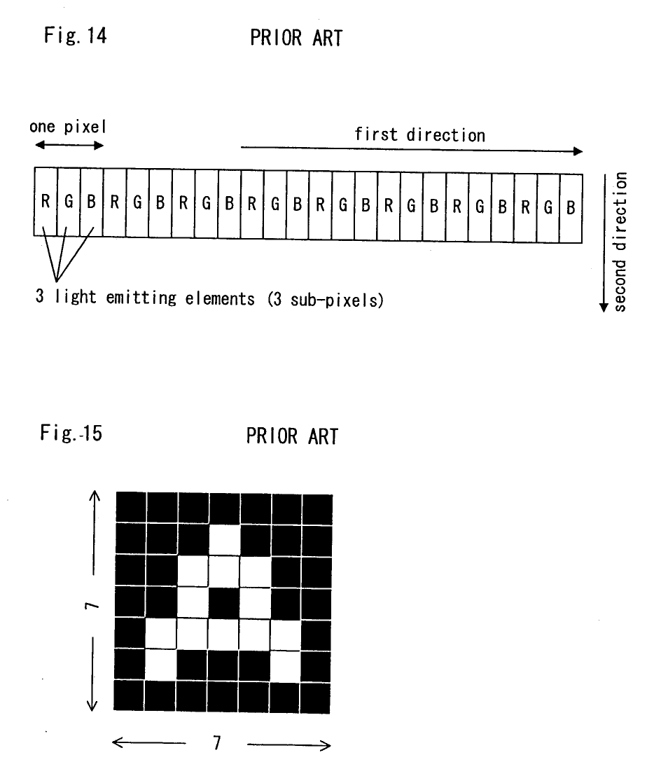

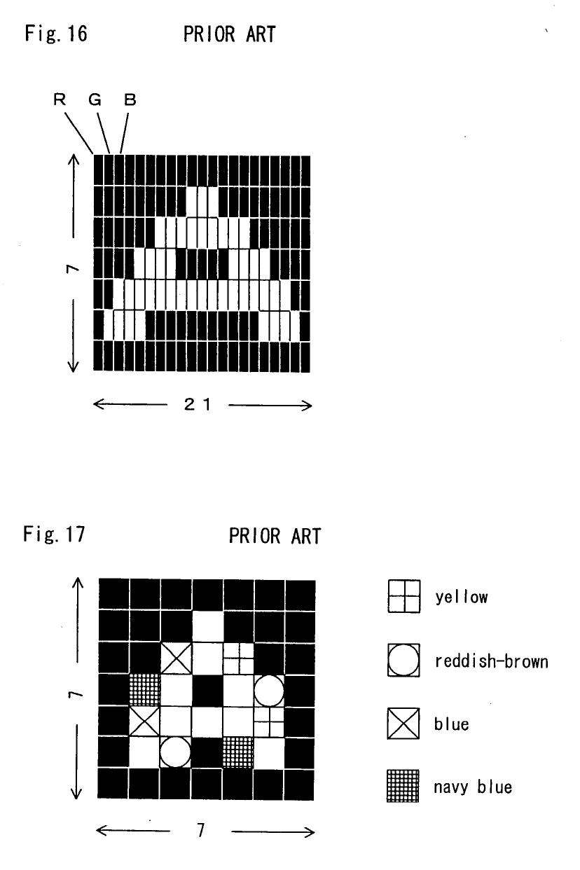

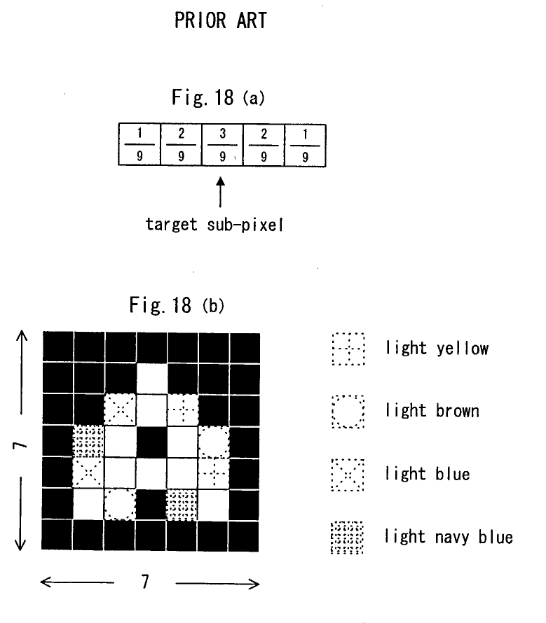

FIG. 13 is a flowchart, illustrating an exemplary flow of processing using the display equipment of FIG. 12. As illustrated in FIG. 13, at step S1, image data is entered into the display equipment. The entered image data is placed as original image data into the original image data storage unit 1.

As step S2, the three-times magnified image data-generating unit 2 references the reference pattern storage unit 3 in accordance with the original image data contained in the original image data storage unit 1, and produces three-times magnified image data.

The three-times magnified image data-generating unit 2 puts the produced three-times magnified image data into the three-times magnified image data storage unit 4.

At step S3, filtering processing unit 14 defines a pixel at an upper-left initial position as a target pixel in the three-times magnified image data stored in the three-times magnified image data storage unit 4.

At step S4, the filtering processing unit 14 generates addresses in accordance with an on-off state of each of a total of seven sub-pixels aligned with each other in the first direction about a target pixel that consists of three sub-pixels RGB.

At step S5, the filtering processing unit 14 checks an original pixel corresponding to the target pixel to see whether the original pixel is displayed in either white or black.

When it is determined at step S6 that the original pixel corresponding to the target pixel is displayed in black, then the filtering processing unit 14 is advanced to step S11.

At step S10, the filtering processing unit 14 references the filter result storage unit 8, and obtains post-filtering processing RGB values (filtering processing results) according to each of the generated addresses.

When it is determined at step S6 that the original pixel correspond to the target pixel is displayed in white, then the filtering processing unit 14 is moved to step S7.

At step S7, the filtering processing unit 14 determines whether blurring occurs in the target pixel corresponding to the original pixel displayed in white in the three-times magnified image contained in the three-times magnified image data storage unit 4. FIG. 2 defines the blurring.

When it is determined at step S8 that the target pixel is not blurred, then the filtering processing unit 14 is advanced to step S10.

At step S10, the filtering processing unit 14 references the filter result storage unit 8, and obtains the post-filtering processing RGB values (filtering processing results) according to each of the generated addresses.

When it is determined at step S8 that the target pixel corresponding to the original pixel displayed in white is blurred, then the filtering processing unit 14 is advanced to step S9.

At step 9, the address change unit 15 changes a target pixel-based address to an address at which filtering processing results for inhibiting target pixel blurring are obtainable.

At step 10, the filtering processing unit 14 references the filter result storage unit 8, and obtains post-filtering processing RGB values (filtering processing results) according to the changed address obtained using the address change unit 15.

As a result, the post-filtering processing RGB values (filtering processing results) in the absence of the blurring are obtainable.

The filtering processing unit 14 is advanced to step S12 when the processing according to step S4 to S10 is not completed for all of the target pixels. At step S12, the next pixel is defined as a target pixel.

The filtering processing unit 14 processes the defined target pixel in accordance with steps S4 to S10

The filtering processing unit 14 repeats the above processing, and is advanced to step S13 when it is determined at step S11 that the entire processing according to step S4 to S10 is completed for all of the target pixels.

The post-filtering processing RGB values are written to the display image storage unit 9.

At step S13, the RGB values written to the display image storage unit 9 are allocated to the display device 10 at corresponding pixels thereof, and are thereby displayed on the display device 10.

In this instance, since a pixel is made up of three sub-pixels RGB (three light-emitting elements RGB), the RGB values are allocated to the three sub-pixels RGB (the three light-emitting elements RGB), respectively.

In this way, the three-times magnified image data contained in the three-times magnified image data storage unit 4 is subjected to the blur-inhibiting processing and the filtering processing, thereby displaying a three-times magnified precision image (a per sub-pixel image) on the display device 10.

As detailed above, according to the present embodiment, it is judged that a displayed target pixel is blurred, either when an original pixel corresponding to the target pixel is in a first display state (i.e., white according to the present embodiment) and target pixel-forming three sub-pixels are in a second display state (i.e., black according to the present embodiment) as illustrated in FIG. 2(a), or when the original pixel corresponding to the target pixel is in the first display state (i.e., white according to the present, embodiment) and only a central sub-pixel among the target pixel-forming three sub-pixels is in the first display state (i.e., white according to the present embodiment) as illustrated in FIG. 2(b).

In this instance, when sub-pixels in the first display state (i.e., white according to the present embodiment) displays the background and sub-pixels in the second display state (i.e., black according to the present embodiment) displays an object (a character, a symbol, a figure, or a combination thereof), then it is judged that the target pixels for displaying the object are blurred, and consequently that a space between object lines is blurred.

To solve the above, filtering processing results for a pixel that includes a larger number of background-displaying sub-pixels in the first display state (i.e., white according to the present embodiment) than the number of the target pixel judged as blurred are obtained from the filter result storage unit 8 as filtering processing results for the target pixel judged as blurred.

As a result, blurring between object lines is inhibited, and an explicit object can be displayed. In addition, the blur-inhibiting processing and the filtering processing are executable at one time.

Furthermore, only one filter result storage unit 8 is required, and a memory having a smaller capacity than that according to the second embodiment may be used.

According to the present embodiment, when the target pixel is blurred as defined by FIG. 2(a), filtering processing results for a pixel that includes a green sub-pixel (the green sub-pixel having the greatest degree of the luminance contribution among three sub-pixels) in the first display state (i.e., white according to the present embodiment) and the remaining two sub-pixels in the second display state (i.e., black according to the present embodiment) are obtained from the filter result storage unit 8, and the obtained filtering processing results are rendered as filtering processing results for target pixel-forming three sub-pixels.

When the target pixel is blurred as defined by FIG. 2(b), filtering processing results for a pixel that includes a central green sub-pixel in the first display state (i.e., white according to the present embodiment), one of the remaining two sub-pixels, which is a red sub-pixel (the red sub-pixel having a greater degree of the luminance contribution between the remaining two sub-pixels) in the first display state (i.e., white according to the present embodiment), and the remainder in the second display state (i.e., black according to the present embodiment) are obtained from the filter result storage unit 8, and the obtained filtering processing results are rendered as filtering processing results for the target pixel-forming three sub-pixels.

As a result, the further suppressed blurring between the object lines is realized, and a more explicit object can be displayed.

The above description assumes that a black object on a white background is illustrated. Alternatively, the background and the object may be displayed in converse colors because an object of any different colors on a background of any different colors may be displayed according to the present embodiment.

A method for generating the three-times magnified image data using the three-times magnified image data-generating unit 2 is not limited to the above. The present embodiment is applicable to a case where the target pixel is blurred as defined in FIG. 2 when the resulting three-times magnified image data are allocated to sub-pixels of the target pixel.

Coefficients used in the filtering processing are not limited to those as illustrated in FIG. 5. Any coefficient may be used according to the present embodiment. For example, according to the present embodiment, the coefficients as illustrated in FIG. 19 may be used.

Although the present embodiment assumes that the sub-pixels are aligned in the order of RGB, the sub-pixels may alternatively be aligned in the order of BGR according to the present embodiment.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An image-processing method comprising:
aligning three sub-pixels with each other in a sequence to form a pixel, the three sub-pixels corresponding to three light-emitting elements that are operable to illuminate three primary colors RGB, respectively;
aligning a plurality of the pixels with each other in a first direction to form a line;
aligning a plurality of the lines with each other in a second direction perpendicular to the first direction, thereby forming a display screen of a display device;
when an original pixel corresponding to a target pixel of an image to be displayed on the display device is in a first display state, and when target pixel-forming three sub-pixels are in a second display state, then permitting one of the target pixel-forming three sub-pixels in the second display state to be rendered in the first display state, thereby providing a target pixel including a sub-pixel that is in the first display state;
when the original pixel corresponding to the target pixel of the image to be displayed on the display device is in the first display state, and when only a central sub-pixel among the target pixel-forming three sub-pixels are in the first display state, then permitting one of the sub-pixels in the second display state among the target pixel-forming three sub-pixels to be rendered in the first display state, thereby providing a target pixel including two sub-pixels that are in the first display state; and
processing the image to be displayed on the display device.

2. An image-processing method as defined in claim 1, wherein said providing the target pixel including the single sub-pixel that is in the first display state comprises permitting a sub-pixel having a greatest degree of a luminance contribution among the target pixel-forming three sub-pixels to be rendered in the first display state, thereby providing a target pixel including a sub-pixel that is in the first display state, and
wherein said providing the target pixel including the two sub-pixels that are in the first display state comprises permitting a sub-pixel having a greater degree of the luminance contribution between two sub-pixels among the target pixel-forming three sub-pixels except for the central sub-pixel to be rendered in the first display state, thereby providing a target pixel including two sub-pixels that are in the first display state.

3. An image-processing method comprising:
aligning three sub-pixels with each other in a sequence to form a pixel, the three sub-pixels corresponding to three light-emitting elements that are operable to illuminate three primary colors RGB, respectively;
aligning a plurality of the pixels with each other in a first direction to form a line;
aligning a plurality of the lines with each other in a second direction perpendicular to the first direction, thereby forming a display screen of a display device;
searching an original image of an image to be displayed on the display device in order to detect an original pixel in a first display state;
when it is found as a result of detecting the original pixel that target pixel-forming three sub-pixels corresponding to the detected original pixel in the first display state are in a second display state, then permitting one of the target pixel-forming three sub-pixels in the second display state to be rendered in the first display state, thereby providing a target pixel including a sub-pixel that is in the first display state;
when it is found as a result of detecting the original pixel that only a central sub-pixel among the target pixel-forming three sub-pixels corresponding to the detected original pixel in the first display state is in the first display state, then permitting one of the sub-pixels in the second display state among the target pixel-forming three sub-pixels to be rendered in the first display state, thereby providing a target pixel including two sub-pixels that are in the first display state; and
processing the image to be displayed on the display device.

4. An image-processing method as defined in claim 3, wherein said providing the target pixel including the sub-pixel that is in the first display state comprises permitting a sub-pixel having a greatest degree of a luminance contribution among the target pixel-forming three sub-pixels to be rendered in the first display state, thereby providing a target pixel including a sub-pixel that is in the first display state, and
wherein said providing the target pixel including the two sub-pixels that are in the first display state comprises permitting a sub-pixel having a greater degree of the luminance contribution between two sub-pixels among the target pixel-forming sub-pixels except for the central sub-pixel to be rendered in the first display state, thereby providing a target pixel including two sub-pixels that are in the first display state.

5. An image-processing method comprising:
aligning three sub-pixels with each other in a sequence to form a pixel, the three sub-pixels corresponding to three light-emitting elements that are operable to illuminate three primary colors RGB, respectively;
aligning a plurality of the pixels with each other in a first direction to form a line;
aligning a plurality of the lines with each other in a second direction perpendicular to the first direction, thereby forming a display screen of a display device;
on assumption that an original pixel corresponding to a target pixel is in a first display state and target pixel-forming three sub-pixels are in a second display state when an image to be displayed on the display device is filtered, then outputting filtering processing results of a state in which one of single pixel-forming three sub-pixels is in the first display state and remaining two sub-pixels are in the second display state;
on assumption that the original pixel corresponding to the target pixel is in the first display state and only a central sub-pixel among the target pixel-forming three sub-pixels is in the first display state when the image to be displayed on the display device is filtered, then outputting filtering processing results of a state in which two sub-pixels including the central sub-pixel among the single pixel-forming three sub-pixels are in the first display state and a remaining sub-pixel is in the second display state; and
processing the image to be displayed on the display device.

6. An image-processing method as defined in claim 5, wherein said outputting the filtering processing results of the state in which one of the single pixel-forming three sub-pixels is in the first display state and the remaining two sub-pixels are in the second display state comprises outputting filtering processing results of a state in which a sub-pixel having a greatest degree of a luminance contribution among the single pixel-forming three sub-pixels is in the first display state and remaining two sub-pixels are in the second display state; and
wherein outputting the filtering processing results of the state in which the two sub-pixels including the central sub-pixel among the single pixel-forming three sub-pixels are in the first display state and the remaining sub-pixel is in the second display state comprises outputting filtering processing results of a state in which the central sub-pixel and a sub-pixel having a greater degree of the luminance contribution between remaining two sub-pixels among the single pixel-forming three sub-pixels are in the first display state and a remaining sub-pixel is in the second display state.

7. An image-processing method comprising:
aligning three sub-pixels with each other in a sequence to form a pixel, the three sub-pixels corresponding to three light-emitting elements that are operable to illuminate three primary colors RGB, respectively;
aligning a plurality of the pixels with each other in a first direction to form a line;
aligning a plurality of the lines with each other in a second direction perpendicular to the first direction, thereby forming a display screen of a display device;
checking a display state of an original pixel that corresponds to a target pixel of an image to be displayed on the display device;
when it is found that the original pixel is in a first display state, then obtaining, from a first filter result storage unit, filtering processing results according to a display state of each of a total of a m-number (m is a natural number) of sub-pixels aligned with each other in the first direction about the target pixel, thereby rendering the obtained filtering processing results being as filtering processing results for target pixel-forming three sub-pixels;
when it is found that the original pixel is in a second display state, then obtaining, from a second filter result storage unit, filtering processing results according to a display state of each of a total of the m-number of sub-pixels aligned with each other in the first direction about the target pixel, thereby rendering the obtained filtering processing results being as filtering processing results for the target pixel-forming three sub-pixels; and
processing the image to be displayed on the display device,
wherein the first and second filter result storage units each contain filtering processing results for single pixel-forming three sub-pixels according to a display state of each of a total of the m-number of sub-pixels aligned with each other in the first direction about a single pixel that consists of the three sub-pixels,
wherein the first filter result storage unit contains, in accordance with a total of the m-number of sub-pixels aligned with each other about a central pixel consisting of three sub-pixels that are in the second display state, filtering processing results of a state in which one of the three sub-pixels for forming the central pixel is in the first display state and remaining two sub-pixels are in the second display state, and
wherein the first filter result storage unit further contains, in accordance with a total of the m-number of sub-pixels aligned with each other about a central pixel consisting of three sub-pixels in which only a central sub-pixel is in the first display state, filtering processing results of a state in which two sub-pixels including the central sub-pixel among the three sub-pixels for forming the central pixel are in the first display state and a remaining sub-pixel is in the second display state.

8. An image-processing method as defined in claim 7, wherein the first filter result storage unit contains, in accordance with a total of the m-number of sub-pixels aligned with each other about the central pixel consisting of the three sub-pixels that are in the second display state, filtering processing results of a state in which a sub-pixel having a greatest degree of a luminance contribution among the three sub-pixels for forming the central pixel is in the first display state and remaining two sub-pixels are in the second display state, and
wherein the first filter result storage unit further contains, in accordance with a total of the m-number of sub-pixels aligned with each other about the central pixel consisting of the three sub-pixels in which only the central sub-pixel is in the first display state, filtering processing results of a state in which the central sub-pixel and a sub-pixel having a greater degree of the luminance contribution between the remaining two sub-pixels among the three sub-pixels for forming the central pixel are in the first display state and a remaining sub-pixel is in the second display state.

9. An image-processing method comprising:
aligning three sub-pixels with each other in a sequence to form a pixel, the three sub-pixels corresponding to three light-emitting elements that are operable to illuminate three primary colors RGB, respectively;
aligning a plurality of the pixels with each other in a first direction to form a line;
aligning a plurality of the lines with each other in a second direction perpendicular to the first direction, thereby forming a display screen of a display device;
checking a display state of an original pixel that corresponds to a target pixel of an image to be displayed on the display device;
obtaining, from a filter result storage unit, filtering processing results according to a display state of each of a total of a m-number (m is a natural number) of sub-pixels aligned with each other in the first direction about the target pixel, thereby rendering the obtained filtering processing results as filtering processing results for target pixel-forming three sub-pixels; and
processing the image to be displayed on the display device,
wherein the filter result storage unit contains filtering processing results for single pixel-forming three sub-pixels according to a display state of each of a total of the m-number of sub-pixels aligned with each other in the first direction about a single pixel that consists of the three sub-pixels, and
wherein said rendering the obtained filtering processing results as filtering processing results for the target pixel-forming three sub-pixels comprises:
when the original pixel is in a first display state, and when the target pixel-forming three sub-pixels are in a second display state, then obtaining, from the filter result storage unit, filtering processing results of a state in which one of central pixel-forming three sub-pixels is in the first display state and remaining two sub-pixels are in the second display state, thereby rendering the obtained filtering processing results as filtering processing results for the target pixel-forming three sub-pixels; and
when the original pixel is in the first display state, and when only a central sub-pixel among the target pixel-forming three sub-pixels is in the first display state, then obtaining, from the filter result storage unit, filtering processing results of a state in which two sub-pixels including the central sub-pixel among the central pixel-forming three sub-pixels are in the first display state and a remaining sub-pixel is in the second display state, thereby rendering the obtained filtering processing results as filtering processing results for the target pixel-forming three sub-pixels.

10. An image-processing method as defined in claim 9, wherein said obtaining, from the filter result storage unit, the filtering processing results of the state in which one of the central pixel-forming three sub-pixels is in the first display state and the remaining two sub-pixels are in the second display state, thereby rendering the obtained filtering processing results as filtering processing results for the target pixel-forming three sub-pixels comprises obtaining, from the filter result storage unit, filtering processing results of a state in which a sub-pixel having a greatest degree of a luminance contribution among the central pixel-forming three sub-pixels is in the first display state and remaining two sub-pixels are in the second display state, thereby rendering the obtained filtering processing results as filtering processing results for the target pixel-forming three sub-pixels, and
wherein said obtaining, from the filter result storage unit, the filtering processing results of the state in which two sub-pixels including the central sub-pixel are in the first display state and the remaining sub-pixel is in the second display state, thereby rendering the obtained filtering processing results as filtering processing results for the target pixel-forming three sub-pixels comprises obtaining, from the filter result storage unit, filtering processing results of a state in which the central sub-pixel and a sub-pixel having a greater degree of the luminance contribution between remaining two sub-pixels among the central pixel-forming three sub-pixels are in the first display state and a remaining sub-pixel is in the second display state, thereby rendering the obtained filtering processing results as filtering processing results for the target pixel-forming three sub-pixels.

11. An image-processing apparatus comprising:
a display device, on which an image is displayed, said image-processing apparatus being operable to process the image;
said display device having three sub-pixels aligned with each other in a sequence to form a pixel, the three sub-pixels corresponding to three light-emitting elements that are operable to illuminate three primary colors RGB, respectively;
a plurality of the pixels aligned with each other in a first direction to form a line;
a plurality of the lines aligned with each other in a second direction perpendicular to the first direction, thereby forming a display screen of said display device;
a first filter result storage unit operable to contain filtering processing results for single pixel-forming three sub-pixels according to a display state of each of a total of a m-number (m is a natural number) aligned with each other in the first direction about a single pixel that includes the three sub-pixels;
a second filter result storage unit operable to contain filtering processing results for single pixel-forming three sub-pixels according to a display state of each of a total of the m-number aligned with each other in the first direction about a single pixel that consists of the three sub-pixels;
a filtering processing unit operable to check a display state of an original pixel corresponding to a target pixel of the image to be displayed on said display device;
said filtering processing unit operable to obtain, from said first filter result storage unit when the original pixel is in a first display state, filtering processing results according to a display state of each of a total of the m-number of sub-pixels aligned with each other in the first direction about the target pixel, thereby rendering the obtained filtering processing results as filtering processing results for target pixel-forming three sub-pixels; and
said filtering processing unit operable to obtain, from said second filter result storage unit when the original pixel is in a second display state, filtering processing results according to a display state of a total of the m-number of sub-pixels aligned with each other in the first direction about the target pixel, thereby rendering the obtained filtering processing results as filtering processing results for the target pixel-forming three sub-pixels,
wherein said first filter result storage unit contains, in accordance with a total of the m-number of sub-pixels aligned with each other about a central pixel including three sub-pixels that are in the second display state, filtering processing results of a state in which one of the three sub-pixels for forming the central pixel is in the first display state and remaining two sub-pixels are in the second display state, and
wherein first second filter result storage unit further contains, in accordance with a total of the m-number of sub-pixels aligned with each other about a central pixel including three sub-pixels in which only a central sub-pixel is in the first display state, filtering processing results of a state in which two sub-pixels including the central sub-pixel among the three sub-pixels for forming the central pixel are in the first display state and a remaining sub-pixel is in the second display state.

12. An image-processing apparatus as defined in claim 11, wherein said first filter result storage unit contains, in accordance with a total of the m-number of sub-pixels aligned with each other about the central pixel including the three sub-pixels that are in the second display state, filtering processing results of a state in which a sub-pixel having a greatest degree of a luminance contribution among the three sub-pixels for forming the central pixel is in the first display state, and remaining two sub-pixels are in the second display state, and
wherein said first filter result storage unit further contains, in accordance with a total of the m-number of sub-pixels aligned with each other about the central pixel including the three sub-pixels in which only the central sub-pixel is in the first display state, filtering processing results of a state in which the central sub-pixel and a sub-pixel having a greater level of the luminance contribution between remaining two sub-pixels among the three sub-pixels for forming the central pixel are in the first display state and a remaining sub-pixel is in the second display state.

13. An image-processing apparatus comprising:
a display device, on which an image is displayed, said image-processing apparatus being operable to process the image;
said display device having three sub-pixels aligned with each other in a sequence to form a pixel, the-three sub-pixels corresponding to three light-emitting elements that are operable to illuminate three primary colors RGB, respectively;
a plurality of the pixels aligned with each other in a first direction to form a line;
a plurality of the lines aligned with each other in a second direction perpendicular to the first direction, thereby forming a display screen of said display device;
a filter result storage unit operable to contain filtering processing results for single pixel-forming three sub-pixels according to a display state of each of a total of a m-number (m is a natural number) aligned with each other in the first direction about a single pixel that consists of the three sub-pixels;
a filtering processing unit operable to check a display state of an original pixel corresponding to a target pixel of the image to be displayed on said display device; and
said filtering processing unit operable to obtain, from said filter result storage unit, filtering processing results according to a display state of each of a total of the m-number of sub-pixels aligned with each other in the first direction about the target pixel, thereby rendering the obtained filtering processing results as filtering processing results for target pixel-forming three sub-pixels,
wherein said filtering processing unit is operable to obtain, from said filter result storage unit, filtering processing results of a state in which one of central single pixel-forming three sub-pixels is the first display state and remaining two sub-pixels are in the second display state when the original pixel is in the first display state and when the target pixel-forming three sub-pixels are in the second display state, thereby rendering the obtained filtering processing results as filtering processing results for the target pixel-forming three sub-pixels, and
wherein said filtering processing unit is operable to obtain, from said filter result storage unit, filtering processing results of a state in which two sub-pixels including a central sub-pixel among the central single pixel-forming three sub-pixels are in the first display state and a remaining sub-pixel is in the second display state when the original pixel is in the first display state and when only the central sub-pixel among the target pixel-forming three sub-pixels is in the first display state, thereby rendering the obtained filtering processing results as filtering processing results for the target pixel-forming three sub-pixels.

14. An image-processing apparatus as defined in claim 13, wherein said filtering processing unit is operable to obtain, from said filter result storage unit, filtering processing results of a state in which a sub-pixel having a greatest level of a luminance contribution among the central single pixel-forming three sub-pixels is the first display state and remaining two sub-pixels are in the second display state when the original pixel is in the first display state and when the target pixel-forming three sub-pixels are in the second display state, thereby rendering the obtained filtering processing results as filtering processing results for the target pixel-forming three sub-pixels, and
wherein said filtering processing unit is operable to obtain, from said filter result storage unit, filtering processing results of a state in which the central sub-pixel and a sub-pixel having a greater degree of the luminance contribution between remaining two sub-pixels among the central single pixel-forming three sub-pixels are in the first display state and a remaining sub-pixel is in the second display state when the original pixel is in the first display state and when only the central sub-pixel among the target pixel-forming three sub-pixels is in the first display state, thereby rendering the obtained filtering processing results as filtering processing results for the target pixel-forming three sub-pixels.

15. An image-processing apparatus comprising:
a display device;
said display device having three sub-pixels aligned with each other in a sequence to form a pixel, the three sub-pixels corresponding to three light-emitting elements that are operable to illuminate three primary colors RGB, respectively;
a plurality of the pixels aligned with each other in a first direction to form a line;
a plurality of the lines aligned with each other in a second direction perpendicular to the first direction, thereby forming a display screen of said display device;
an image-processing unit operable to permit one of sub-pixels in a second display state among target pixel-forming three sub-pixels to be rendered in a first display state to provide a target pixel including a sub-pixel that is in the first display state when an original pixel corresponding to a target pixel of an image to be displayed on said display device is in the first display state, and when the target pixel-forming three sub-pixels are in the second display state; and
said image-processing unit operable to permit one of sub-pixels in the second display state among the target pixel-forming three sub-pixels to be rendered in the first display state to provide a target pixel including two sub-pixels that are in the first display state when the original pixel corresponding to the target pixel of the image to be displayed on said display device is in the first display state, and when only a central sub-pixel among the target pixel-forming three sub-pixels is in the first display state.

16. An image-processing apparatus as defined in claim 15, wherein said image-processing unit is operable to permit a sub-pixel having a greatest degree of a luminance contribution among target pixel-forming three sub-pixels to be rendered in the first display state to provide a target pixel including a sub-pixel that is in the first display state when the original pixel corresponding to the target pixel of the image to be displayed on said display device is in the first display state, and when the target pixel-forming three sub-pixels are in the second display state, and
wherein said image-processing unit is operable to permit a sub-pixel having a greater degree of the luminance contribution between two sub-pixels among the target pixel-forming three sub-pixels except for a central sub-pixel to be rendered in the first display state to provide a target pixel including two sub-pixels that are in the first display state when the original pixel corresponding to the target pixel of the image to be displayed on said display device is in the first display state, and when only the central sub-pixel among the target pixel-forming three sub-pixels is in the first display state.

17. An image-processing apparatus comprising:
a display device;
said display device having three sub-pixels aligned with each other in a sequence to form a pixel, the three sub-pixels corresponding to three light-emitting elements that are operable to illuminate three primary colors RGB, respectively;
a plurality of the pixels aligned with each other in a first direction to form a line;
a plurality of the lines aligned with each other in a second direction perpendicular to the first direction, thereby forming a display screen of said display device;
an image-processing unit operable to output filtering processing results of a state in which one of single pixel-forming three sub-pixels is in a first display state and remaining two sub-pixels are in a second display state, assuming that an original pixel corresponding to a target pixel is in the first display state and target pixel-forming three sub-pixels are in the second display state when an image to be displayed on said display device is filtered; and
said image-processing unit operable to output filtering processing results of a state in which two sub-pixels including a central sub-pixel among the single pixel-forming three sub-pixels are in the first display state and a remaining sub-pixel is in the second display state, assuming that the original pixel corresponding to the target pixel is in the first display state and only the central sub-pixel among the target pixel-forming three sub-pixels is in the first display state when an image to be displayed on said display device is filtered.

18. An image-processing apparatus as defined in claim 17, wherein said image-processing unit is operable to output filtering processing results of a state in which a sub-pixel having a greatest degree of a luminance contribution among the single pixel-forming three sub-pixels is in the first display state and remaining two sub-pixels are in the second display state when the original pixel corresponding to the target pixel is in the first display state, and when the target pixel-forming three sub-pixels are in the second display state, and
wherein said image-processing unit is operable to output filtering processing results of a state in which the central sub-pixel and a sub-pixel having a greater degree of the luminance contribution between remaining two sub-pixels among the single pixel-forming three sub-pixels are in the first display state and a remaining sub-pixel is in the second display state, assuming that the original pixel corresponding to the target pixel is in the first display state and only the central sub-pixel among the target pixel-forming three sub-pixels is in the first display state when an image to be displayed on said display device is filtered.
